(19) United States
(12) Patent Application Publication
(10) Pub. No.: US 2023/0369628 A1
(43) Pub. Date: Nov. 16, 2023

(54) Fuel Cell Stack

(71) Applicant: Hitachi, Ltd., Tokyo (JP)

(72) Inventors: Yoshitaka SASAGO, Tokyo (JP); Noriyuki SAKUMA, Tokyo (JP); Natsuki YOKOYAMA, Tokyo (JP); Ryuusei FUJITA, Tokyo (JP)

(21) Appl. No.: 18/139,742

(22) Filed: Apr. 26, 2023

(30) Foreign Application Priority Data
May 12, 2022 (JP) 2022-079115

(51) Int. Cl. H01M 8/24; H01M 8/2465; H01M 8/04089; H01M 8/0271

(52) U.S. Cl. CPC H01M 8/2459; H01M 8/2465; H01M 8/04089; H01M 8/0271

(57) ABSTRACT

A preferred aspect of the present invention is a fuel cell stack provided with a plurality of fuel cells each including a solid electrolyte layer and first and second electrode layers formed across the solid electrolyte layer. The fuel cells are stacked with the first or second electrode layers of adjacent cells facing each other. A common flow path for supplying a first gas to both of the first electrode layers facing each other is formed in an area where the first electrode layers face each other. A common flow path for supplying a second gas to both of the second electrode layers facing each other is formed in an area where the second electrode layers face each other. A connection electrode is formed at the end of the fuel cell. At least some of the stacked cells are connected in series via the connection electrode.

### BACKGROUND OF THE INVENTION

### 1. Field of the Invention

The present invention relates to a stack structure of a fuel cell.

### 2. Description of the Related Art

JP 2021-61199 A, JP 2015-230822 A, and JP 2013-58370 A are patent literatures as the related art of the field of the invention.

JP 2021-61199 A discloses a technique in which a plurality of fuel cells are electrically connected in series and arranged in a plane, a plurality of structures in which the fuel cells are connected in series in the plane are further stacked to form a stack, and the fuel cells are connected in series in the stacking direction as well.

The theoretical electromotive force of the fuel cell is determined by the type and partial pressure of fuel gas and oxidant gas used to generate electricity, the operating temperature, and other factors. When a current is allowed to pass so as to take out the output to the outside, a voltage drop occurs due to ohmic resistance of an electrolyte inside the fuel cell, polarization resistance at an interface between a cathode layer and an electrolyte layer, polarization resistance at an interface between an anode layer and the electrolyte layer, resistance of a current collector or an interconnector for taking out a current from the anode layer and the cathode layer to the outside, resistance of a cable for taking out a current to the outside of the stack, or the like, and the output power decreases.

When the fuel cells are connected in series to each other, it is possible to generate power by increasing the voltage and reducing the current, compared to a case where the fuel cells are connected in parallel. For this reason, when the fuel cells are connected in series to each other, it is possible to reduce a voltage drop due to the resistance of the current collector or the interconnector, the resistance of the cable for taking out a current to the outside of the stack, or the like, that is, a decrease in output power.

In the stack of JP 2021-61199 A, the fuel cells are stacked in the same direction. That is, the anode layer of the fuel cell in a certain plane faces the cathode layer of the fuel cell adjacent in the stacking direction across the separator interposed therebetween, and the cathode layer of the fuel cell in a certain plane faces the anode layer of the fuel cell adjacent in the stacking direction with the separator interposed therebetween. Due to the need for supplying fuel gas to the anode layer and oxidant gas to the cathode layer, a separator is required between the fuel cells adjacent in the stacking direction to separate these two types of gases. The fuel gas is supplied while flowing through the boundary between the separator and the anode layer, and the oxidant gas is supplied while flowing through the boundary between the separator and the cathode layer.

JP 2015-230822 A discloses a stacking technique in which mutually adjacent anode layers of fuel cells are caused to face each other, and fuel gas is supplied to a gap between the facing portions. When the fuel gas is supplied to the area where the anode layers of the adjacent fuel cell face each other, the fuel gas can be supplied to both of the adjacent fuel cells. In the stack of JP 2015-230822 A, fuel cells in the same plane are connected in series to each other. The stack of JP 2015-230822 A does not disclose an example in which fuel cells in adjacent planes are connected in series.

JP 2013-58370 A discloses a stacking technique in which mutually adjacent cathode layers of fuel cells are caused to face each other, and oxidant gas is supplied to a gap between the facing portions. As in the case of the fuel gas of JP 2015-230822 A, when the oxidant gas is supplied to the area where the cathode layers of the adjacent fuel cell of JP 2013-58370 A face each other, the oxidant gas can be supplied to both of the adjacent fuel cells. The stack of JP 2013-58370 A does not disclose an example in which fuel cells in adjacent planes are connected in series.

### SUMMARY OF THE INVENTION

In the method described in JP 2021-61199 A, it is necessary to form the flow path of the fuel gas and the flow path of the oxidant gas for each layer of the stack. In the stacking direction, the fuel cell, the flow path of the fuel gas, the separator, and the flow path of the oxidant gas are sequentially and repeatedly stacked on the anode layer side of the fuel cell to form a stack. The flow path of the fuel gas and the flow path of the oxidant gas need to be thick enough to supply the amount required for power generation for one fuel cell layer with a small differential pressure between the outlet and inlet of each flow path. In addition, a separator for separating the flow path of the fuel gas and the flow path of the oxidant gas is required between the flow path of the fuel gas and the flow path of the oxidant gas. As a result, it becomes difficult to reduce the thickness of the stack and size reduction.

In the methods described in JP 2015-230822 A and JP 2013-58370 A, the flow path of the fuel gas or the flow path of the oxidant gas can be shared by the fuel cells on adjacent planes. This is advantageous compared to the method of JP 2021-61199 A in terms of the ease of reducing the flow path in the thickness direction because there is no need to separate the flow path of the fuel gas and the flow path of the oxidant gas with the separator.

However, in the method of JP 2015-230822 A, while a technique for connecting fuel cells in the same plane in series is disclosed, a technique for connecting fuel cells in different planes in series is not disclosed. As described in JP 2021-61199 A, a voltage drop due to parasitic resistance, that is, a decrease in output, can be reduced by increasing the voltage at the output of the fuel cell stack to reduce the current, but only connecting the fuel cells in the plane in series is not sufficient. Neither does JP 2013-58370 A disclose a technique for connecting fuel cells in different planes in series.

The present invention has been made in view of the above problems, and an object of the present invention is to provide a fuel cell system with a small volume per output and high power generation efficiency.

A preferred aspect of the present invention is a fuel cell stack provided with a plurality of fuel cells each including a solid electrolyte layer and a first electrode layer and a second electrode layer that are formed across the solid electrolyte layer, the plurality of fuel cells being stacked with the first electrode layers or the second electrode layers of adjacent cells facing each other. A common flow path that supplies a first gas to both of the first electrode layers facing each other is formed in an area where the first electrode layers face each other. A common flow path that supplies a second gas to both of the second electrode layers facing each other is formed in an area where the second electrode layers face each other. A connection electrode is formed at an end of the fuel cell. At least some of the plurality of fuel cells stacked are connected in series via the connection electrode.

Another preferred aspect of the present invention is a fuel cell stack provided with: a plurality of metal substrate layers each having a structure in which a plurality of through-holes serving as a flow path of a first gas, a plurality of through-holes serving as a flow path of a second gas, and one through-hole for a fuel cell or a plurality of through-holes for fuel cells are formed, and connection is made to the plurality of through-holes serving as the flow path of the first gas or the plurality of through-holes serving as the flow path of the second gas via a flow path formed inside each of the plurality of metal substrate layers; and fuel cells each including an electrolyte layer, and a first electrode layer and a second electrode layer formed across the electrolyte layer, the fuel cells being bonded to both surfaces of each of the plurality of metal substrate layers so as to cover the through-hole for the fuel cell with the first electrode layers or the second electrode layers facing each other. The metal substrate layers are stacked such that the plurality of through-holes serving as the flow path of the first gas and the plurality of through-holes serving as the flow path of the second gas are connected in a stacking direction at an interval ensuring space for the flow path so as to prevent contact between the fuel cells bonded to each of the metal substrate layers. At least some of the fuel cells bonded to front and back surfaces of the metal substrate layers are each electrically connected to the first electrode layer of the fuel cell on one of the surfaces and electrically connected to the second electrode layer of the fuel cell on the other of the surface to be electrically connected in series in the stacking direction via the metal substrate layer.

According to the present invention, it is possible to provide a fuel cell system having a small volume per output and high power generation efficiency. Problems, structures, and effects other than those described above will be described in the following embodiments.

### BRIEF DESCRIPTION OF THE DRAWINGS

FIG. 1 is a two-view diagram showing a general structure of a fuel cell including a solid electrolyte layer;

FIG. 2 is a cross-sectional view taken along a flow path of oxidant gas, showing a configuration example of a fuel cell stack according to a first embodiment;

FIG. 3 is a cross-sectional view taken along a flow path of fuel gas, showing a configuration example of the fuel cell stack according to the first embodiment;

FIG. 4 is a cross-sectional view of a cross section perpendicular to the flow path of the oxidant gas and the flow path of the fuel gas, showing a configuration example of the fuel cell stack according to the first embodiment;

FIG. 5 is a circuit diagram showing the equivalent circuit of the fuel cell stack in FIG. 2 according to the first embodiment;

FIG. 6 is a plan view showing an example of a structure of a metal support substrate with a through-hole open in the fuel cell stack according to the first embodiment;

FIG. 7 is a plan view showing an example of the structure of the metal support substrate with the through-hole open in the fuel cell stack according to the first embodiment;

FIG. 8A is a graph showing an effect of the first embodiment;

FIG. 8B is a cross-sectional view comparing the stack of the first embodiment and the stack of a comparative example;

FIG. 9A is a graph showing another effect of the first embodiment;

FIG. 9B is a cross-sectional view showing a cross-sectional structure of the first embodiment;

FIG. 10 is a cross-sectional view showing another configuration example of the fuel cell stack according to the first embodiment;

FIG. 11 is a circuit diagram showing the equivalent circuit of the fuel cell stack in FIG. 10 according to the first embodiment;

FIG. 12 is a cross-sectional view taken along a flow path of the oxidant gas, showing a configuration example of the fuel cell stack according to the first embodiment different from FIG. 2;

FIG. 13 is a cross-sectional view taken along a flow path of the fuel gas, showing a configuration example of the fuel cell stack according to the first embodiment different from FIG. 3;

FIG. 14 is a cross-sectional view of a cross section perpendicular to a flow path of oxidant gas and a flow path of fuel gas, showing a configuration example of a fuel cell stack according to a second embodiment;

FIG. 15 is a circuit diagram showing the equivalent circuit of the fuel cell stack in FIG. 14 according to the second embodiment;

FIG. 16 is a cross-sectional view of a cross section perpendicular to a flow path of oxidant gas and a flow path of fuel gas, showing a configuration example of a fuel cell stack according to a third embodiment;

FIG. 17 is a circuit diagram showing the equivalent circuit of the fuel cell stack in FIG. 16 according to the third embodiment;

FIG. 18 is a plan view showing an example of the structure of the metal support substrate with the through-hole open in the fuel cell stack according to the third embodiment;

FIG. 19 is a plan view showing an example of the structure of the metal support substrate with the through-hole open in the fuel cell stack according to the third embodiment;

FIG. 20 is a cross-sectional view showing another configuration example of the fuel cell stack according to the third embodiment;

FIG. 21 is a circuit diagram showing the equivalent circuit of the fuel cell stack in FIG. 20 according to the third embodiment;

FIG. 22 is a cross-sectional view showing another configuration example of the fuel cell stack according to the third embodiment;

FIG. 23 is a circuit diagram showing the equivalent circuit of the fuel cell stack in FIG. 22 according to the third embodiment;

FIG. 24 is a plan view showing a configuration example of a fuel cell stack according to a fourth embodiment;

FIG. 25 is a cross-sectional view taken along a flow path of oxidant gas, showing a configuration example of the fuel cell stack according to the fourth embodiment;

FIG. 26 is a cross-sectional view taken along a flow path of fuel gas, showing a configuration example of the fuel cell stack according to the fourth embodiment;

FIG. 27 is a plan view showing another configuration example of the fuel cell stack according to the fourth embodiment;

FIG. 28 is a cross-sectional view taken along a flow path of the oxidant gas of the fuel cell stack in FIG. 27 according to the fourth embodiment;

FIG. 29 is a cross-sectional view taken along a flow path of the fuel gas of the fuel cell stack in FIG. 27 according to the fourth embodiment;

FIG. 30 is a cross-sectional view of a cross section perpendicular to the flow path of the oxidant gas and the flow path of the fuel gas of the fuel cell stack in FIG. 27 according to the fourth embodiment;

FIG. 31 is a cross-sectional view taken along a flow path of oxidant gas, showing a configuration example of a fuel cell stack according to a fifth embodiment;

FIG. 32 is a cross-sectional view taken along a flow path of fuel gas, showing a configuration example of the fuel cell stack according to the fifth embodiment;

FIG. 33 is a cross-sectional view of a cross section perpendicular to the flow path of the oxidant gas and the flow path of the fuel gas, showing a configuration example of the fuel cell stack according to the fifth embodiment;

FIG. 34 is a circuit diagram showing the equivalent circuit of the configuration example of the fuel cell stack according to the fifth embodiment;

FIG. 35 is a cross-sectional view of a cross section perpendicular to the flow path of the oxidant gas and the flow path of the fuel gas, showing a configuration example of the fuel cell stack according to the fifth embodiment; and

FIG. 36 is a circuit diagram showing the equivalent circuit of the configuration example of the fuel cell stack according to the fifth embodiment.

### DESCRIPTION OF THE PREFERRED EMBODIMENTS

Hereinafter, embodiments will be described in detail with reference to the drawings. In all the drawings for describing the embodiments, members having the same function are denoted by the same or related reference numerals, and repeated descriptions thereof will be omitted. When there are a plurality of similar members (parts), symbols may be added to the generic reference signs to indicate individual or specific parts. In the following embodiments, descriptions of the same or similar parts will not be repeated in principle unless particularly necessary.

In the following embodiments, an X direction, a Y direction, and a Z direction are used as directions for description. The X direction and the Y direction are orthogonal to each other and are directions constituting a horizontal plane, and the Z direction is a direction perpendicular to the horizontal plane.

In the drawings used in the embodiments, even in a cross-sectional view, hatching may be omitted to make the drawing easier to see. Even in a plan view, hatching may be applied to make the drawing easier to see.

In the cross-sectional view and the plan view, the size of each part does not correspond to that in the actual device, and a specific part may be displayed relatively large for easy understanding of the drawing. When the cross-sectional view and the plan view correspond, a specific part may be displayed relatively large for easy understanding of the drawing.

In the embodiment, a description will be given of a fuel cell stack provided with a unit including a first fuel cell and a second fuel cell. Each of the first fuel cell and the second fuel cell includes a solid electrolyte layer and an anode layer and a cathode layer that are formed across the solid electrolyte layer. In the unit, the first fuel cell and the second fuel cell are stacked with the anode layers or the cathode layers facing each other. A gas flow path is formed between the first fuel cell and the second fuel cell disposed to face each other. The fuel cells are electrically connected in series. An example in which the first fuel cell and the second fuel cell are electrically connected in parallel will also be described. An example in which the first fuel cell and the second fuel cell are electrically connected in series will also be described.

A fuel cell stack according to the embodiment is provided with a cell group including independent fuel cells formed on the same plane or a plurality of fuel cells formed on the same plane and having anode layers and cathode layers oriented in the same direction. A plurality of cell groups are stacked in the thickness direction of the fuel cell. The anode layers or the cathode layers of the fuel cells adjacent in the stacking direction face each other. A flow path of fuel gas is shared in space where the anode layers face each other between the fuel cells adjacent in the stacking direction. A flow path of oxidant gas is shared in space where the cathode layers face each other between the fuel cells adjacent in the stacking direction.

When the cell group is formed of independent fuel cells, the cell groups are connected in series in the stacking direction via connection portions at the ends of the fuel cell. When the cell group is formed of a plurality of fuel cells, at least some of the fuel cells in the cell group can be connected to each other in series, and the cell groups are connected to each other in series via connection portions at the cell ends in the stacking direction. The series connection in the stacking direction can be performed both between cell groups in which the anode layers face each other and between cell groups in which the cathode layers face each other, but can also be performed only either between cell groups in which the anode layers face each other or between cell groups in which the cathode layers face each other.

According to the above embodiment, it is possible to reduce the size of the fuel cell stack in the thickness direction of the fuel cell, reduce a decrease in output due to a voltage drop in parasitic resistance, and reduce both the hardware cost and the running cost of the fuel cell stack. Hereinafter, a detailed description will be given with reference to the drawings.

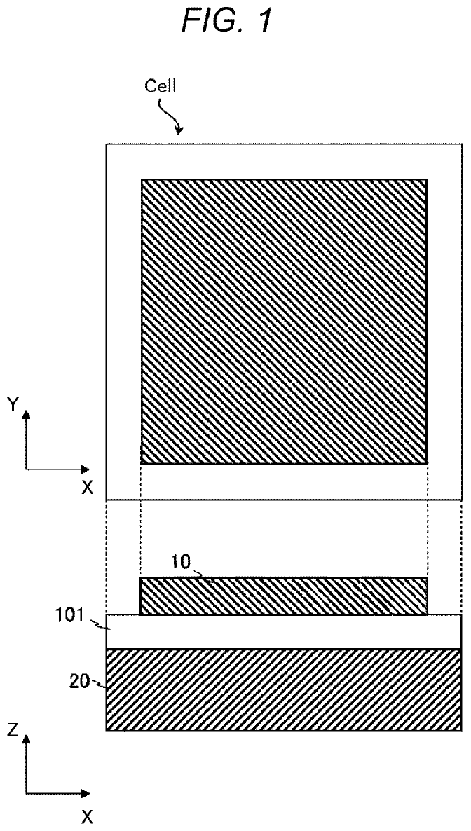

FIG. 1 is a plan view and a cross-sectional view showing a general structure of a fuel cell Cell including a solid electrolyte layer 101. An anode layer 20 and a cathode layer 10 are formed on each surface of solid electrolyte layer 101. For the solid electrolyte layer 101, for example, zirconia doped with yttria (YSZ) can be used. For the anode layer 20, for example, a composite material layer made of YSZ and nickel can be used. For the cathode layer 10, for example, an oxide electrode layer having a composition such as La_{0.5}Sr_{0.5}CoO_{3-δ} (LSC) can be used. The mechanical strength of the fuel cell Cell can be ensured by, for example, making the anode layer 20 several hundred micrometers thick and sufficiently thick.

The output of one fuel cell Cell in FIG. 1 is usually not sufficient, and hence a fuel cell stack is formed using a plurality of fuel cells Cell so that sufficient output can be generated. In the fuel cell stack, arbitrary fuel cells Cell are connected in series to increase the voltage. Alternatively, arbitrary fuel cells Cell are connected in parallel to increase the current. In the fuel cell stack, in addition to electrically connecting the plurality of fuel cells Cell, it is necessary to provide a flow path for supplying fuel gas to the anode layer 20 of each fuel cell Cell and supplying oxidant gas to the cathode layer 10 of each fuel cell Cell.

### First Embodiment

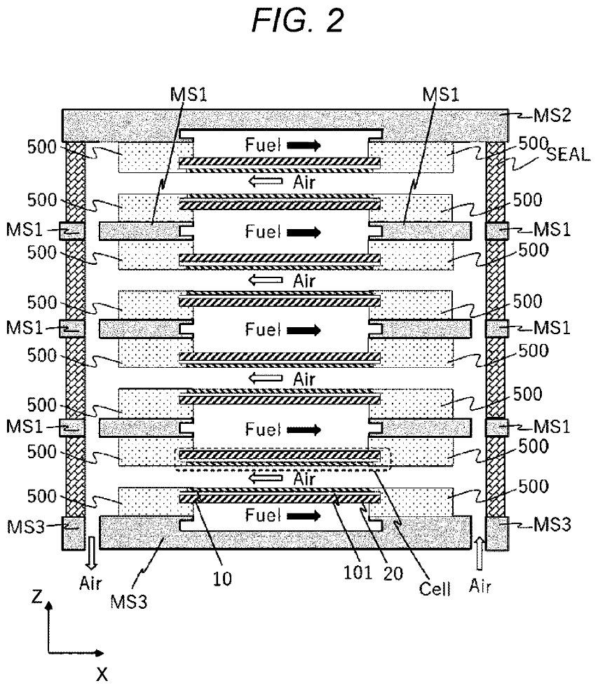

FIG. 2 is a schematic view showing a configuration example of a fuel cell stack using a solid oxide fuel cell (SOFC) according to a first embodiment of the present invention and is a cross-sectional view taken along a flow path of air (oxidant gas) Air.

Each layer in the fuel cell stack is formed of, for example, the fuel cells Cell as shown in FIG. 1, and the direction of the fuel cells Cell adjacent in the stacking direction (Z direction) is inverted in the stacking direction (Z direction). That is, the anode layers 20 and the cathode layers 10 alternately face each other between the fuel cells Cell adjacent in the stacking direction.

The fuel cell Cell is bonded to a metal substrate layer (MS1, MS2, MS3) by an insulator layer 500 at each end in the X direction. In this bonding portion, the fuel cell Cell and the metal substrate layer (MS1, MS2, MS3) are electrically insulated by the insulator layer 500. The metal substrate layer (MS1, MS2, MS3) can be formed of stainless used steel (SUS), for example.

In a case where power is generated by the fuel cell stack, air (oxidant gas) Air is supplied to the stack from the right hole of the metal substrate layer MS3 at the lower portion of FIG. 2, and is supplied to the area where the cathode layers 10 face each other between the fuel cells Cell adjacent in the stacking direction. In a stack where a large number of fuel cells Cell are stacked, a plurality of areas where the cathode layers 10 face each other between the fuel cells Cell adjacent in the stacking direction are formed in parallel in the stacking direction.

In FIG. 2, four different areas are formed in the stacking direction, and air Air is supplied to each area. During power generation, oxygen in the air Air deprives electrons from the cathode layer 10 of each fuel cell Cell and is converted from the state of oxygen molecules to two oxygen ions O²⁻. The oxygen ions O²⁻ conduct through the solid electrolyte layer 101 to reach the anode layer 20 side, and change into water vapor by reaction with fuel gas, which will be described later. By these reactions, the cathode layer 10 operates as a positive electrode with respect to the outside of the fuel cell, and the anode layer 20 operates as a negative electrode.

The components of the air Air except for oxygen changed to oxygen ions O²⁻ in the cathode layer 10 join on the left side of FIG. 2 and are released to the outside of the stack from the left hole of the metal substrate layer MS3 at the lower portion of FIG. 2. The flow path of the air Air in the stack and the outside air are connected at the left and right holes of the metal substrate layer MS3 described above, that is, the introduction port portion and the discharge port portion of the air Air, but other parts are shielded by a sealing material SEAL and the metal substrate layer (MS1, MS2, MS3). The sealing material SEAL is electrically an insulator. As the sealing material SEAL, for example, a glass material, a ceramic material, a vermiculite-based material, or the like can be used.

FIG. 2 also shows a state where fuel gas Fuel is supplied to an area where the anode layers 20 face each other between the fuel cells Cell adjacent in the stacking direction. For the fuel gas Fuel, for example, hydrogen can be used. The fuel gas Fuel flows in a direction opposite to the air Air as indicated by an arrow in FIG. 2. Note that only a part of the fuel gas Fuel is shown in the cross section of FIG. 2, not the entire flow, because the introduction port from the outside of the stack and the discharge port to the outside of the stack are not shown.

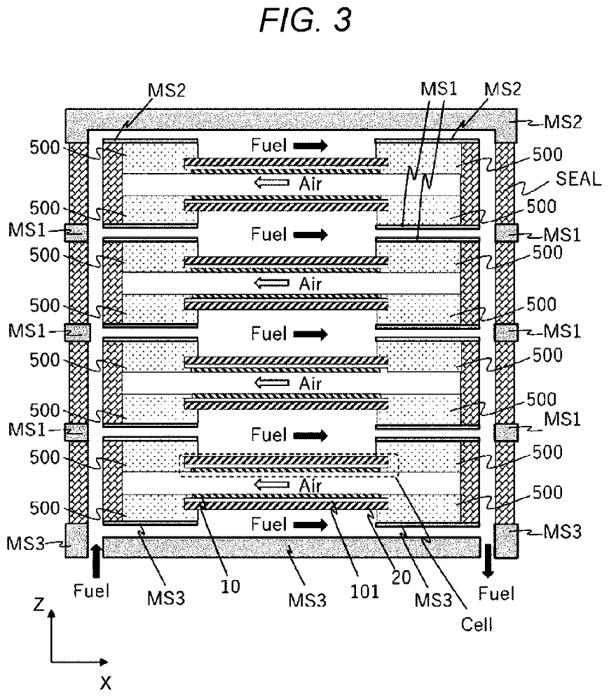

FIG. 3 is a schematic view showing a configuration example of a fuel cell stack using the SOFC according to the first embodiment and is a cross-sectional view along the flow path of the fuel gas Fuel. The cross section taken along the X-Z plane is the same as that in FIG. 2, but the position in the depth direction (Y direction) is different. The shown fuel cell is the same as that of FIG. 2, and the anode layers 20 and the cathode layers 10 alternately face each other between the fuel cells Cell adjacent in the stacking direction.

In a case where power is generated by the fuel cell stack, the fuel gas Fuel is supplied to the stack from the left hole of the metal substrate layer MS3 at the lower portion of FIG. 3, and is supplied to the area where the anode layers 20 face each other between the fuel cells Cell adjacent in the stacking direction. In a stack where a large number of fuel cells Cell are stacked, a plurality of areas where the anode layers 20 face each other between the fuel cells Cell adjacent in the stacking direction are formed in parallel in the stacking direction.

In FIG. 3, three different areas are formed in the stacking direction, and the fuel gas Fuel is supplied to each area. The fuel gas Fuel is also supplied to a boundary portion between the anode layer 20 of the lowermost fuel cell Cell and the metal substrate layer MS3, and a boundary portion between the anode layer 20 of the uppermost fuel cell Cell and the metal substrate layer MS2.

During power generation, for example, hydrogen in the fuel gas Fuel reacts with the above-described oxygen ions conducted from the cathode layer 10 side through the solid electrolyte layer 101 at a boundary portion between the anode layer 20 and the solid electrolyte layer 101 of each fuel cell Cell to generate water vapor. At this time, electrons are transmitted to the anode layer 20, and are supplied to the outside when the outside of the fuel cell Cell is not an open circuit. As described above, by these reactions, the cathode layer 10 operates as the positive electrode with respect to the outside of the fuel cell, and the anode layer 20 operates as the negative electrode.

Some of the components of the fuel gas Fuel change to water vapor at the boundary portion between the anode layer 20 and the solid electrolyte layer 101, merge on the right side of FIG. 3, and are discharged to the outside of the stack from the right hole of the metal substrate layer MS3 at the lower portion of FIG. 3. The flow path of the fuel gas Fuel in the stack and the outside air are connected at the left and right holes of the metal substrate layer MS3 described above, that is, the introduction port portion and the discharge port portion of the fuel gas Fuel, but other parts are shielded by a sealing material SEAL and the metal substrate layer (MS1, MS2, MS3). The sealing material SEAL is electrically an insulator.

FIG. 3 also shows a state where the air Air is supplied to an area where the cathode layers 10 face each other between the fuel cells Cell adjacent in the stacking direction. The air Air flows in a direction opposite to that of the fuel gas Fuel as indicated by an arrow in FIG. 3. Note that only a part of the air Air is shown in the cross section of FIG. 3, not the entire flow, because the introduction port from the outside of the stack and the discharge port to the outside of the stack are not shown.

The flow path of the air Air and the flow path of the fuel gas Fuel are separated by the fuel cell Cell, the insulator layer 500 that fixes the fuel cell Cell, an anode contact ACONT layer, and a cathode contact CCONT layer, and ideally, the air Air and the fuel gas Fuel do not mix with each other in a gaseous state.

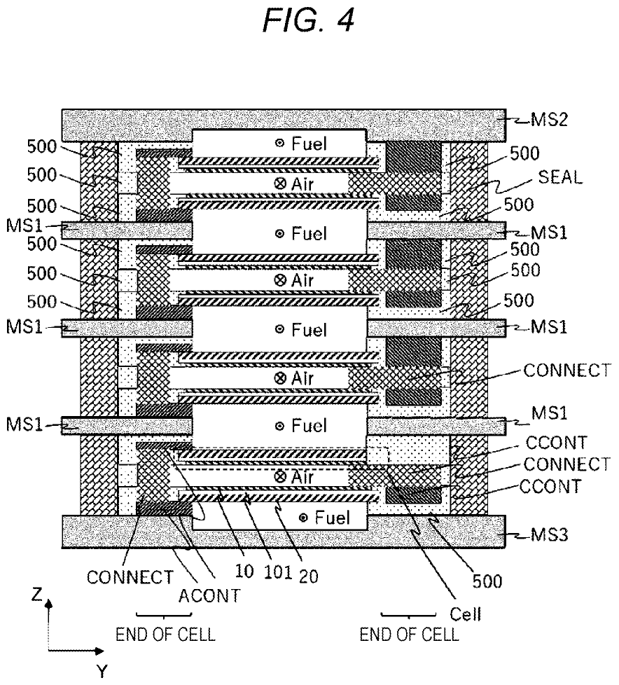

FIG. 4 is a cross-sectional view of the stack shown in FIGS. 2 and 3 on the Y-Z plane. The air Air and the fuel gas Fuel flow in directions opposite to each other in a direction perpendicular to the paper surface. Unlike FIGS. 2 and 3, FIG. 4 shows neither the introduction port from the outside nor the discharge port to the outside for the air Air or the fuel gas Fuel.

The electrical connection between the fuel cells Cell shown in FIG. 4 will be described. The lowermost metal substrate layer MS3 is formed of a low-resistance metal material and is connected to a negative electrode that outputs power to the outside of the stack. The uppermost metal substrate layer MS2 is also formed of a low-resistance metal material and is connected to a positive electrode that outputs power to the outside of the stack. The metal substrate layer MS1 disposed at a place where the anode layers 20 of the fuel cells Cell face each other is also formed of a low-resistance metal material and serves not only to ensure the mechanical strength of the stack as a support substrate for the fuel cells Cell but also to electrically connect the fuel cell Cell groups adjacent in the Z direction.

The fuel cell Cell is electrically bonded to the metal substrate layer (MS1, MS2, MS3) at each end in the Y direction. In an area where the metal substrate layer MS3 and the metal substrate layer MS1 face each other, two fuel cells Cell are disposed with the cathode layers 10 facing each other. The anode layers 20 of the two fuel cells Cell are electrically connected at a connection portion CONNECT via the anode contact ACONT at the end of the left fuel cell Cell of FIG. 4 and are also electrically connected to the metal substrate layer MS3. The cathode layers 10 of the two fuel cells Cell are electrically connected to each other at the connection portion CONNECT at the end of the right fuel cell Cell of FIG. 4 and are also electrically connected to the metal substrate layer MS1 via the cathode contact CCONT.

Also, in an area where the two metal substrate layers MS1 face each other, two fuel cells Cell are disposed with the cathode layers 10 facing each other. The anode layers 20 of the two fuel cells Cell are electrically connected at the connection portion CONNECT via the anode contact ACONT at the end of the left fuel cell Cell of FIG. 4 and are also electrically connected to the lower metal substrate layer MS1 of the upper and lower metal substrate layers MS1. The cathode layers 10 of the two fuel cells Cell are electrically connected to each other at the connection portion CONNECT at the end of the right fuel cell Cell of FIG. 4 and are also electrically connected to the upper metal substrate layer MS1 of the upper and lower metal substrate layers MS1 via the cathode contact CCONT.

In an area where the metal substrate layer MS1 and the metal substrate layer MS2 face each other, two fuel cells Cell are disposed with the cathode layers 10 facing each other. The anode layers 20 of the two fuel cells Cell are electrically connected at the connection portion CONNECT via the anode contact ACONT at the end of the left fuel cell Cell of FIG. 4 and are also electrically connected to the metal substrate layer MS1. The cathode layers 10 of the two fuel cells Cell are electrically connected to each other at the connection portion CONNECT at the end of the right fuel cell Cell of FIG. 4 and are also electrically connected to the metal substrate layer MS2 via the cathode contact CCONT.

A state is also shown where the air Air and the fuel gas Fuel are supplied in a direction perpendicular to the paper surface to an area where the cathode layers 10 face each other between the fuel cells Cell adjacent in the stacking direction. The air Air and the fuel gas Fuel flow in opposite directions. In the cross section of FIG. 4, neither the introduction port from the outside of the stack nor the discharge port to the outside of the stack are shown for the air Air or the fuel gas Fuel.

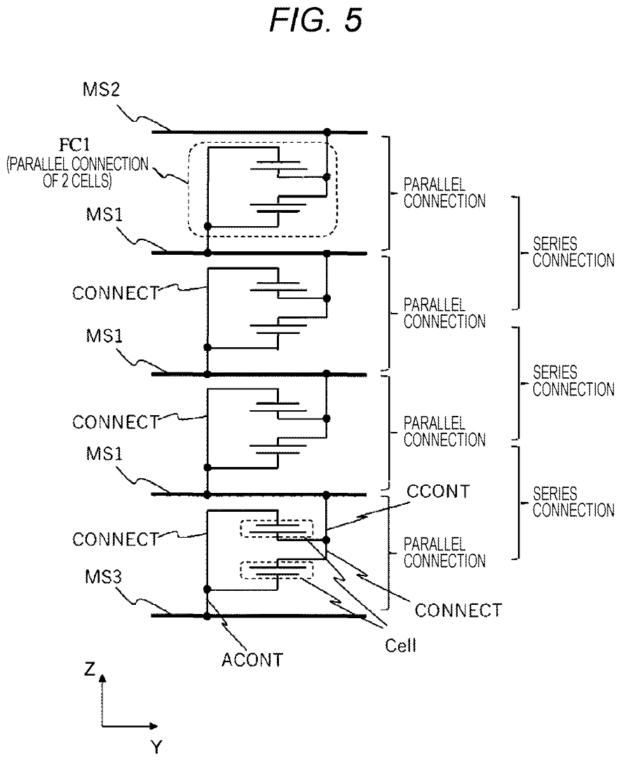

FIG. 5 shows the equivalent circuit diagram of the fuel cell stack shown in FIGS. 2 to 4. Two fuel cells Cell disposed between the metal substrate layer MS3 and the metal substrate layer MS1 are disposed with the cathode layers 10 (positive electrodes) facing each other. The metal substrate layer MS3 is connected to the anode layers 20 (negative electrodes) of these two fuel cells Cell, and the metal substrate layer MS1 is connected to the cathode layers 10 (positive electrodes) of these two fuel cells Cell. These two fuel cells Cell are connected in parallel to the metal substrate layer MS3 and the metal substrate layer MS1.

Similarly, two fuel cells Cell are disposed between two metal substrate layers MS1 adjacent in the Z direction with the cathode layers 10 facing each other. These two fuel cells Cell are connected in parallel to the two metal substrate layers MS1 adjacent in the Z direction. Two fuel cells Cell disposed between the metal substrate layer MS1 and the metal substrate layer MS2 are also disposed with the cathode layers 10 (positive electrodes) facing each other. These two fuel cells Cell are connected in parallel to the metal substrate layer MS1 and the metal substrate layer MS2.

Two fuel cells Cell disposed adjacent in the Z direction at the boundary between the metal substrate layers (MS1, MS2, MS3) with the cathode layers 10 (positive electrodes) facing each other are connected in parallel to form a structure (FC1 in FIG. 5), and the formed structures are connected in series via the metal substrate layers (MS1, MS2, MS3) to form the structure of the entire equivalent circuit.

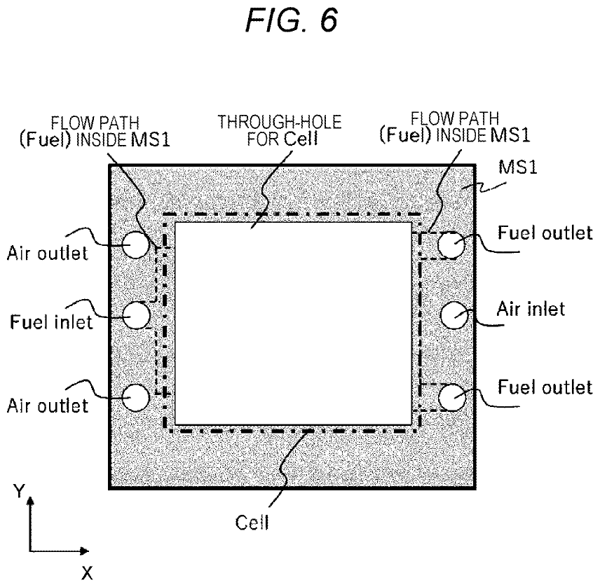

FIG. 6 shows a plan view of the metal substrate layer MS1 for realizing the fuel cell stack structure of FIGS. 2 to 4. Through-holes for supplying gas to the fuel cell stack formed by stacking in the Z direction are formed at both ends in the X direction of the metal substrate layer MS1. One inlet Fuel Inlet of the fuel gas Fuel and two outlets Air Outlet of the air Air are formed at the left end of FIG. 6. Two outlets Fuel Outlet of the fuel gas Fuel and one inlet Air Inlet of the air Air are formed at the right end of FIG. 6.

In the center of the metal substrate layer MS1, a through-hole for the fuel cell Cell is open at a place where the fuel cell Cell is disposed. The through-hole for the fuel cell Cell is connected from the inlet Fuel Inlet of the fuel gas Fuel and the outlet Fuel Outlet of the fuel gas Fuel by a flow path (Fuel) formed inside the metal substrate layer MS1. Thanks to this flow path (Fuel), the fuel gas Fuel can be supplied from the inlet Fuel Inlet of the fuel gas Fuel to the anode layer 20 of the fuel cell Cell when the fuel cell stack is formed, and unreacted gas, water vapor, and the like can be discharged from the outlet Fuel Outlet of the fuel gas Fuel.

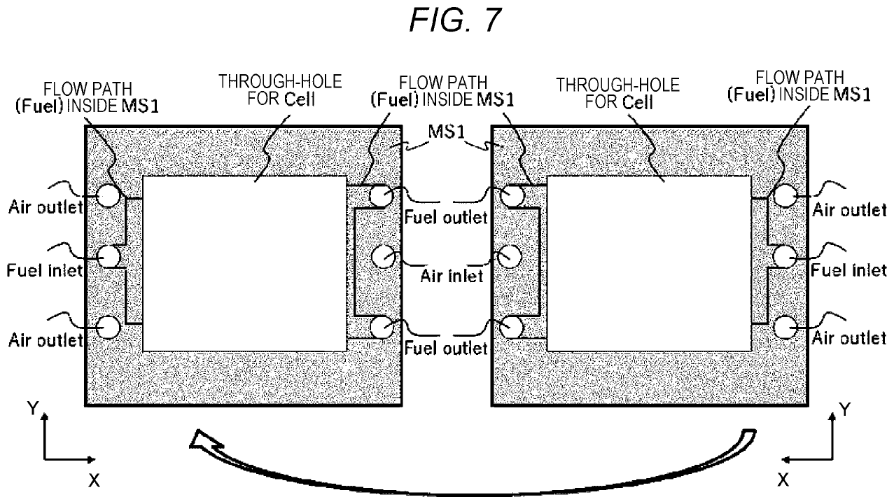

FIG. 7 shows a preparation example of the metal substrate layer MS1 in FIG. 6. The metal substrate layer MS1 in FIG. 6 can be produced by weld-bonding two metal substrate layers having a line-symmetrical structure with respect to the Y axis as shown in FIG. 7, or to put it another way, two metal substrate layers having a front and back inverted symmetrical structure. In this case, if the metal substrate layers before bonding are structured to be line-symmetrical with respect to the X axis, for example, the metal substrate layer MS1 can be produced by bonding two metal substrate layers with the same structure. Only one type of metal substrate layer is required before bonding, thus facilitating the promotion of cost reduction during mass production.

### First Embodiment: Effects

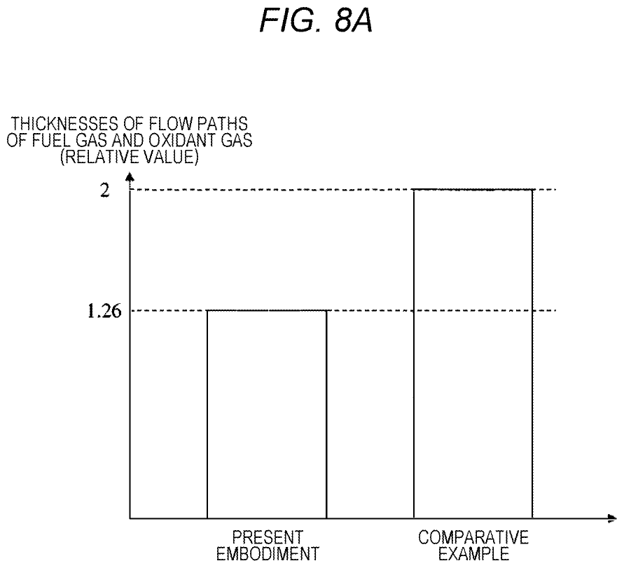

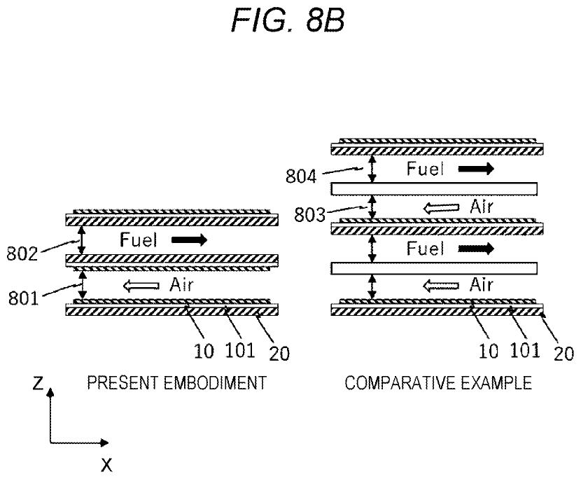

FIG. 8A is a diagram showing the effect of the first embodiment as the present embodiment, and is a graph comparing the thicknesses of the flow path of the fuel gas and the flow path of the oxidant gas between the cell stacks of the present embodiment and a comparative example.

FIG. 8B is a comparative diagram showing the cell stack structures of the present embodiment and the comparative example. As shown in FIG. 8B, in the fuel cell stack according to the first embodiment as the present embodiment, the flow path of the air Air and the flow path of the fuel gas Fuel need to supply necessary air Air and fuel gas Fuel to fuel cell Cell above and below the flow path. That is, a width 801 of the flow path of the air Air and a width 802 of the flow path of the fuel gas Fuel each cover the flow rates of two cells. Compared to a case where the fuel cell Cell is provided on one side of the flow path as in the comparative example, in the embodiment, it is necessary to supply twice as much the air Air and twice as much the fuel gas Fuel per unit time in the respective flow paths.

It is necessary to increase the height of the flow path, that is, the widths 801, 802 in the Z direction in order to flow twice the air Air and twice the fuel gas Fuel per unit time while maintaining the differential pressure between the air Air and the fuel gas Fuel at both ends of the fuel cell Cell along the X direction constant. It is less advantageous when the height of the flow path required at this time is twice as large as a width 803 of the flow path of the air Air and a width 804 of the flow path of the fuel gas Fuel for one cell in the case where the fuel cell Cell is present on one side of the flow path. However, when the height of the flow path can be made smaller than twice, the gas flow path is shared by two layers of the fuel cells Cell, so that the total of the widths of the flow path in the Z direction can be reduced in the total of the entire fuel cell stack.

A case where a laminar flow is assumed as the flows of the air Air and the fuel gas Fuel, and the width in the Y direction is sufficiently larger than the width in the Z direction is considered as the shape of the flow path. This is a situation realized in a normal SOFC stack. In this case, the amounts of the air Air and the fuel gas Fuel that can flow per unit time when the differential pressure is constant are proportional to the cube of the width in the Z direction. Thus, to double the amount of gas allowed to flow, the width in the Z direction may be set to 2^{(1/3)} times≈1.26 times. That is, when the gas flow path is shared, the width of the flow path of the air Air in the Z direction and the width of the flow path of the fuel gas Fuel in the Z direction can be reduced to:

2^{(1/3)}÷2≈0.63 times (FIG. 8A).

When the technique of the first embodiment as the present embodiment is used, the width of the flow path of the air Air in the Z direction and the width of the flow path of the fuel gas Fuel in the Z direction can be reduced to about 0.63 times, and furthermore, as a result of connecting the fuel cells Cell in series, the current can be reduced and the output voltage can be increased compared to the case of the parallel connection, so that the influence of the voltage drop due to parasitic resistance can be reduced.

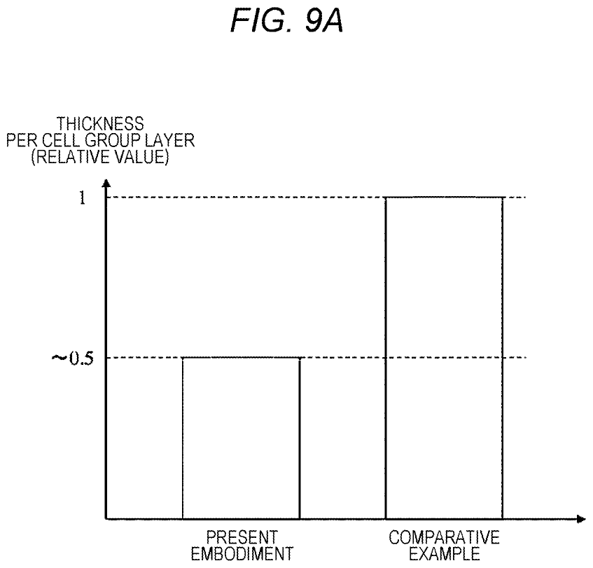

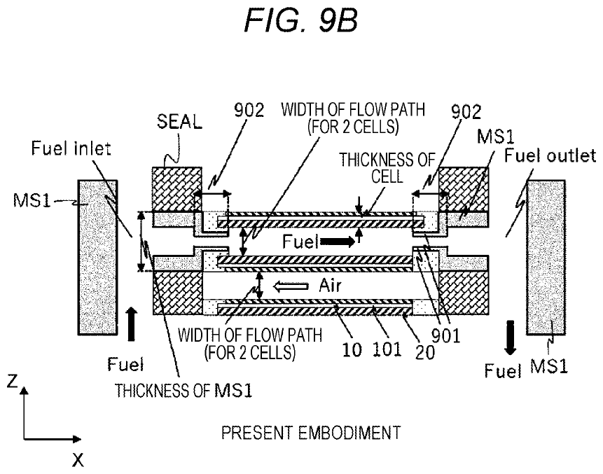

FIG. 9A is a diagram showing the effect of the first embodiment as the present embodiment and is a graph comparing the thickness per cell group layer between the cell stacks of the present embodiment and the comparative example.

FIG. 9B is a diagram showing another effect of the first embodiment as the present embodiment.

Related to the effects shown in FIGS. 8A and 8B, the thickness of the stack per layer of the fuel cell Cell in the Z direction can be reduced by the technique of the first embodiment as the present embodiment. In the flat cell stack of the comparative example, the thickness in the Z direction of the structure for one cell layer is the sum of the thickness of one cell layer, the thickness of one flow path layer of the fuel gas Fuel, the thickness of one flow path layer of the air Air, and the thickness of one separator layer.

However, in the case of the technique of the first embodiment as the present embodiment, the thickness in the Z direction of the structure for one layer of the fuel cell Cell is substantially equal to the sum of the thickness of one layer of the fuel cell Cell, the thickness of one flow path layer of the fuel gas Fuel (0.63 times that of the conventional flat cell stack), the thickness of one flow path layer of the air Air (0.63 times that of the conventional flat cell stack), and half the thickness of the metal substrate layer MS1 (substantially equal to half the thickness of the separator in the conventional flat cell stack).

Moreover, depending on the structure of the metal substrate layer MS1, as shown in FIG. 9B, the metal substrate layer MS1 can be disposed such that the occupied area thereof in the Z direction overlaps the flow path of the fuel gas Fuel or the occupied area of the fuel cell Cell in the Z direction.

As shown in FIG. 9B, a drop hole is formed in the metal substrate layer MS1 where the fuel cell Cell just enters, and an eaves portion 901 is formed so as to prevent the fuel cell Cell from dropping to the opposite side of the metal substrate layer MS1 through the through-hole for the fuel cell. This can further reduce the thickness of the stack per layer of the fuel cell Cell in the Z direction.

In this case, the thickness in the Z direction of the structure for one layer of the fuel cell Cell is the sum of the thickness of one layer of the fuel cell Cell, the thickness of one flow path layer of the fuel gas Fuel (0.63 times that of the conventional flat cell stack), and the thickness of one flow path layer of the air Air (0.63 times that of the conventional flat cell stack). As a result, as shown in FIG. 9A, the thickness of the stack per one layer of the fuel cell Cell in the Z direction can be reduced to about half of that of the conventional flat cell stack by the technique of the first embodiment as the present embodiment.

In the structure of FIG. 9B, in a route in which the fuel gas Fuel is supplied from the inlet Fuel Inlet of the fuel gas Fuel to the anode layer 20 of the fuel cell Cell and further discharged to the outlet Fuel Outlet of the fuel gas Fuel, two constricted portions 902 of the flow path are formed where the width of the flow path in the Z direction is smaller than that of the area where the cathode layers 10 of the fuel cells Cell face each other. The length along the flow path (the length in the X direction) of the constricted portion 902 of the flow path is much shorter than the length along the flow path (the length in the X direction) of the fuel cell Cell, so that it is possible to reduce the influence on the differential pressure required at the time of allowing a necessary amount of the fuel gas Fuel to flow.

### First Embodiment: First Modification

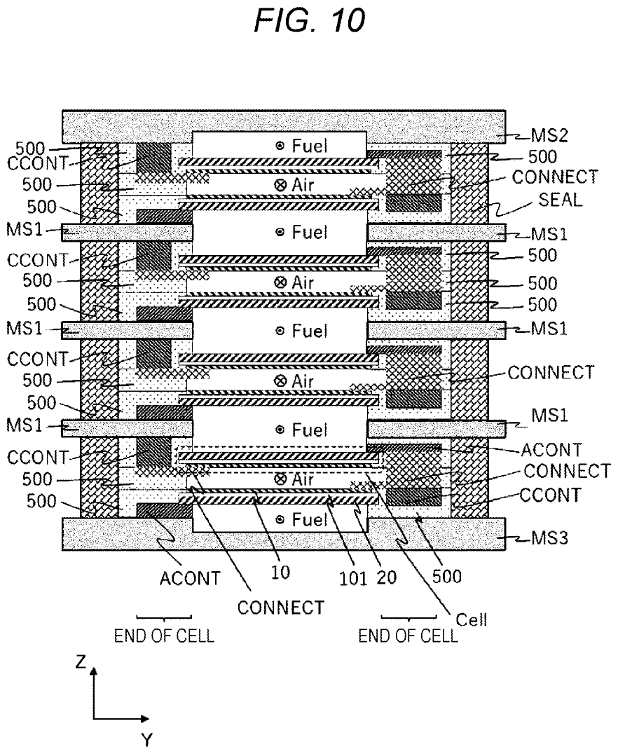

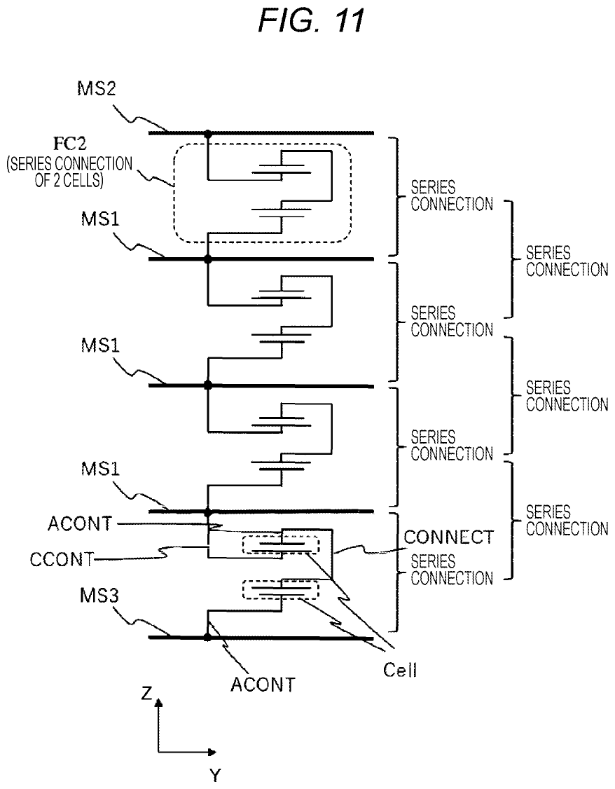

In FIGS. 2 to 5, the two fuel cells Cell disposed between the metal substrate layers (MS1, MS2, MS3) adjacent in the Z direction have been connected in parallel, but may be connected in series as shown in FIGS. 10 and 11.

The electrical connection between the fuel cells Cell shown in FIG. 10 will be described. The mechanical configuration and electrical connection of the fuel cells Cell and the metal substrate layers MS1 to MS3 are basically similar to those described with reference to FIG. 4. The different parts will be described below.

The anode layer 20 of the lower fuel cell Cell is electrically connected to the metal substrate layer MS3 via the anode contact ACONT at the end of the left fuel cell Cell of FIG. 10. The cathode layer 10 of the lower fuel cell Cell is electrically connected to the anode contact ACONT of the upper fuel cell Cell via the connection portion CONNECT at the end of the right fuel cell Cell of FIG. 10.

The connection portion CONNECT is connected to the cathode contact CCONT. The anode contact ACONT of the upper fuel cell Cell is electrically connected to the anode layer 20 of the upper fuel cell Cell. The cathode layer 10 of the upper fuel cell Cell is connected to the cathode contact CCONT via the connection portion CONNECT, and the cathode contact CCONT is connected to the metal substrate layer MS1.

As described above, in the area where the metal substrate layer MS3 and the metal substrate layer MS1 face each other, the two fuel cells Cell are connected in series between the metal substrate layer MS3 and the metal substrate layer MS1. Also between two metal substrate layers MS1 adjacent in the Z direction, two cells are disposed with the cathode layers 10 facing each other, and these two fuel cells Cell are connected to the two metal substrate layers MS1 in series. The same applies between the metal substrate layer MS1 and the metal substrate layer MS2. Note that the cross sections of the structure of FIG. 10 taken along the X-Z plane are substantially the same as those in FIGS. 2 and 3, and the description thereof is thus omitted.

FIG. 11 shows the equivalent circuit diagram of the fuel cell stack shown in FIG. 10. Two fuel cells Cell disposed between the metal substrate layer MS3 and the metal substrate layer MS1 are disposed with the cathode layers 10 (positive electrodes) facing each other. The metal substrate layer MS3 is connected to the anode layer 20 (negative electrode) of the lower fuel cell Cell, and the cathode layer 10 of the lower fuel cell Cell is connected to the anode layer 20 of the upper fuel cell Cell via the connection portion CONNECT and the anode contact ACONT. The cathode layer 10 of the upper fuel cell Cell is connected to the metal substrate layer MS1 via the connection portion CONNECT and the cathode contact CCONT.

Similarly, two fuel cells Cell are disposed between two metal substrate layers MS1 adjacent in the Z direction with the cathode layers 10 facing each other. These two fuel cells Cell are connected in series to the two metal substrate layers MS1 adjacent in the Z direction. Two fuel cells Cell disposed between the metal substrate layer MS1 and the metal substrate layer MS2 are also disposed with the cathode layers 10 (positive electrodes) facing each other, and these two fuel cells Cell are connected in series to the metal substrate layer MS1 and the metal substrate layer MS2.

Two fuel cells Cell disposed adjacent in the Z direction at the boundary between the metal substrate layers (MS1, MS2, MS3) with the cathode layers 10 (positive electrodes) facing each other are connected in series to form a structure (FC2 in FIG. 11), and the formed structures are further connected in series via the metal substrate layers (MS1, MS2, MS3) to form the structure of the entire equivalent circuit.

Also, in the modification of the first embodiment shown in FIGS. 10 and 11, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In the fuel cell stacks in FIGS. 2 to 5, two fuel cells Cell between the adjacent metal substrate layers (MS1, MS2, MS3) have been connected in parallel, whereas in the fuel cell stacks in FIGS. 10 and 11, the two fuel cells Cell have been connected in series. This can increase the output voltage of the stack and reduce the current, so that the effect of reducing a decrease in output power due to parasitic resistance is large.

### First Embodiment: Second Modification

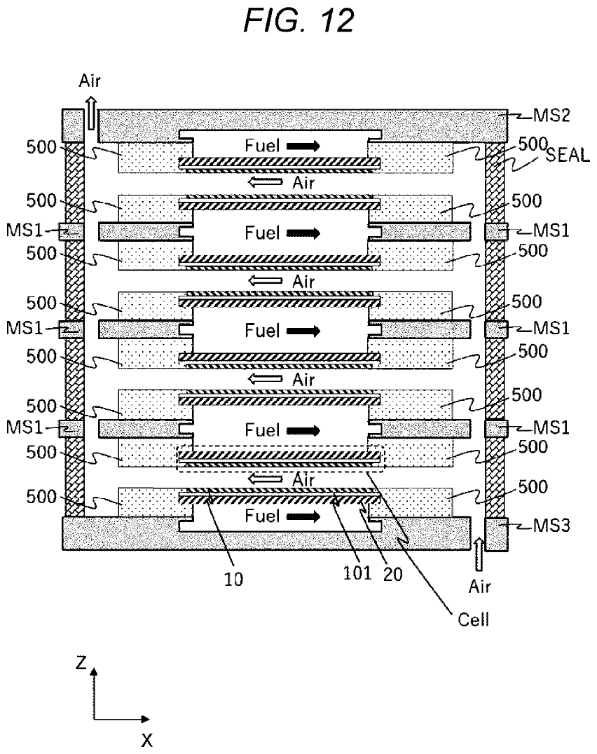

FIG. 12 shows a second modification of the first embodiment in which a plurality of cells in the plane are connected in series in the stacking direction.

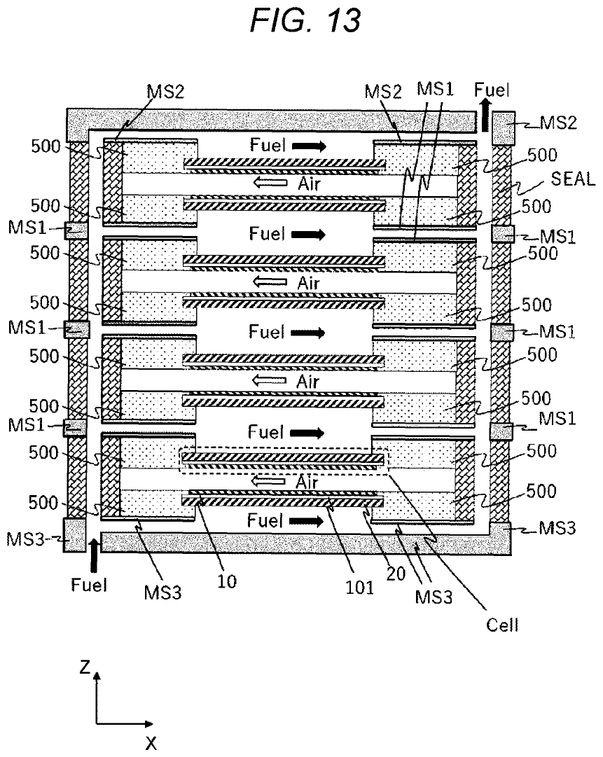

FIG. 13 shows another second modification of the first embodiment, in which a plurality of cells in the plane are connected in series in the stacking direction.

In FIGS. 2 to 3, the inlet and the outlet for supplying the fuel gas Fuel and the air Air to the fuel cell stack have both been formed at the lower portion of the fuel cell stack, that is, in the metal substrate layer MS3. However, for example, as shown in FIG. 12, the introduction port for the air Air may be formed at the lower portion (metal substrate layer MS3) of the fuel cell stack, and the discharge port for the air Air may be formed at the upper portion (metal substrate layer MS2) of the fuel cell stack.

As shown in FIG. 13, the introduction port for the fuel gas Fuel may be formed at the lower portion (metal substrate layer MS3) of the fuel cell stack, and the discharge port for the fuel gas Fuel may be formed at the upper portion (metal substrate layer MS2) of the fuel cell stack. The introduction port and the discharge port for the air Air and the introduction port and the discharge port for the fuel gas Fuel can be formed in either the upper portion or the lower portion of the fuel cell stack. The positions of the introduction port and the discharge port for the air Air and the introduction port and the discharge port for the fuel gas Fuel can be selected depending on the type and layout of the gas piping connected to the introduction port and the discharge port for the air Air and the introduction port and the discharge port for the fuel gas Fuel.

Also, in the modification of the first embodiment shown in FIGS. 12 and 13, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell.

### Second Embodiment

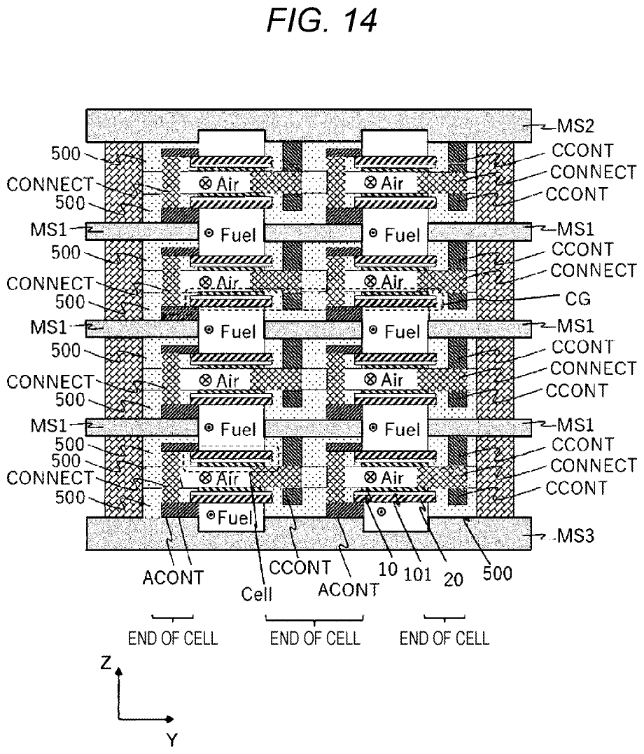

In the first embodiment, a cell group CG has been formed of one fuel cell Cell. That is, one fuel cell Cell has been formed for each layer, but the cell group CG may be formed of a plurality of fuel cells Cell as in a second embodiment as the present embodiment. FIG. 14 is an example of a fuel cell stack according to the second embodiment as the present embodiment in which the cell group CG is formed of two fuel cells Cell, and shows a cross-sectional view taken along the Y-Z plane. The cross-sections of the X-Z plane are similar to those of FIGS. 2 and 3, and the description thereof is thus omitted.

The electrical connection between the fuel cells Cell shown in FIG. 14 will be described. The mechanical configuration and electrical connection of the fuel cells Cell and the metal substrate layers MS1 to MS3 are basically similar to those described with reference to FIG. 4. The different parts will be described below.

In an area where the metal substrate layer MS3 and the metal substrate layer MS1 face each other, two each of four fuel cells Cell are disposed with the cathode layers 10 facing each other. The anode layers 20 of the two fuel cells Cell are electrically connected via the anode contact ACONT at the connection portion CONNECT at the left ends of the two left fuel cells Cell of FIG. 14 and are also electrically connected to the metal substrate layer MS3. The cathode layers 10 of the two fuel cells Cell are electrically connected to each other at the connection portion CONNECT at the right end of the left fuel cell Cell of FIG. 14 and are also electrically connected to the metal substrate layer MS1 via the cathode contact CCONT. The cell on the right side of FIG. 14 is also connected to the metal substrate layer MS3 and the metal substrate layer MS1 similarly to the left fuel cell Cell.

Also, in an area where two metal substrate layers MS1 adjacent in the Z direction face each other and an area where the metal substrate layer MS1 and the metal substrate layer MS2 face each other, two each of four fuel cells Cell are disposed with the cathode layers 10 facing each other. The electrical connection is similar to the four fuel cells Cell disposed between the metal substrate layer MS3 and the metal substrate layer MS1.

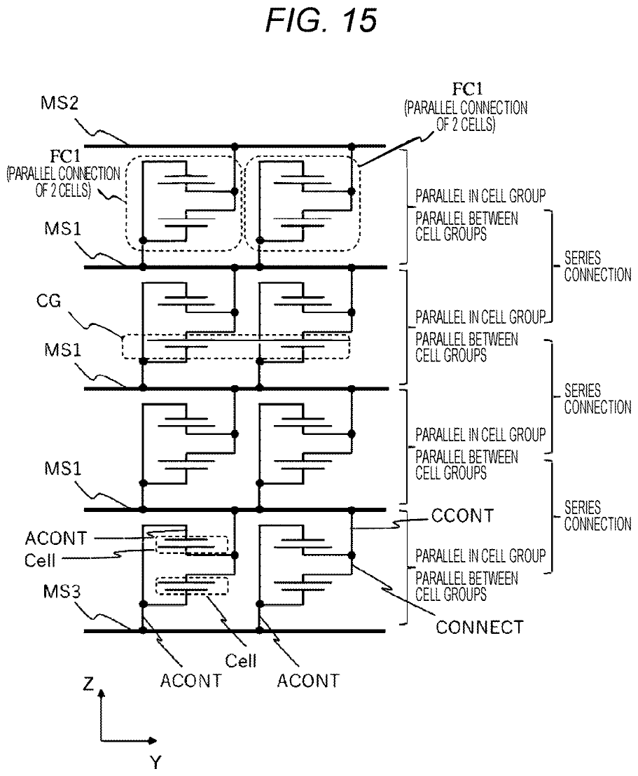

FIG. 15 shows the equivalent circuit diagram of the fuel cell stack shown in FIG. 14 in which a plurality of cells in the plane are connected in series in the stacking direction. Two each of four fuel cells Cell disposed between the metal substrate layer MS3 and the metal substrate layer MS1 are disposed with the cathode layers 10 (positive electrodes) facing each other. Two left fuel cells disposed with the cathode layers 10 facing each other and two cells on the right side disposed with the cathode layers 10 facing each other each form a parallel connection structure (FC1) of two fuel cells Cell and are connected in parallel the metal substrate layer MS3 and the metal substrate layer MS1.

Similarly, two each of four fuel cells Cell are also disposed between two metal substrate layers MS1 adjacent in the Z direction with the cathode layers 10 facing each other. Two left fuel cells disposed with the cathode layers 10 facing each other and two cells on the right side disposed with the cathode layers 10 facing each other each form a parallel connection structure (FC1) of two fuel cells Cell and are connected in parallel between the two metal substrate layers MS1.

Similarly, two each of four fuel cells Cell disposed between the metal substrate layer MS1 and the metal substrate layer MS2 are also disposed with the cathode layers 10 (positive electrodes) facing each other. Two left fuel cells disposed with the cathode layers 10 facing each other and two cells on the right side disposed with the cathode layers 10 facing each other each form a parallel connection structure (FC1) of two fuel cells Cell and are connected in parallel between the two metal substrate layers MS1.

Two pairs of two fuel cells Cell disposed adjacent in the Z direction at the boundary of the metal substrate layers (MS1, MS2, MS3) with the cathode layers 10 (positive electrodes) facing each other form two parallel connection structures (FC1) of two fuel cells Cell, and these two FC1 are further connected in parallel to form a structure. The formed structures are connected in series via the metal substrate layers (MS1, MS2, MS3) to form the structure of the entire equivalent circuit.

Comparing FIGS. 4 and 5 of the first embodiment with FIGS. 14 and 15 of the second embodiment as the present embodiment, in FIGS. 4 and 5 of the first embodiment, one parallel connection FC1 of two fuel cells Cell is disposed at each boundary of the metal substrate layer (MS1, MS2, MS3), whereas in FIGS. 14 and 15 of the second embodiment as the present embodiment, two sets of parallel connections FC1 are disposed at the boundary of each metal substrate layer (MS1, MS2, MS3) and are further connected in parallel with each other. It is naturally possible to arrange not two but three or more sets of parallel connections FC1 of two fuel cells Cell at the boundary of each metal substrate layer (MS1, MS2, MS3).

Also, in the fuel cell stack of the second embodiment shown in FIGS. 14 and 15, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In addition, unlike the fuel cell stack according to the first embodiment, the cell group CG includes a plurality of fuel cells Cell, and the effect is that the output of the stack can be easily improved with a small number of stacked cells.

### Second Embodiment: Modification

In FIGS. 14 and 15, two pairs of two fuel cells Cell each disposed between the metal substrate layers (MS1, MS2, MS3) adjacent in the Z direction have been connected in parallel, but two fuel cells Cell with the cathode layers 10 facing each other can also be connected in series.

In order to connect two fuel cells Cell with the cathode layers 10 facing each other in series, two fuel cells Cell between the adjacent metal substrate layers (MS1, MS2, MS3) may be connected in series in the configuration shown in FIGS. 10 and 11. In FIG. 11, one structure (FC2) in which two fuel cells Cell are connected in series is formed between the metal substrate layers (MS1, MS2, MS3) adjacent in the Z direction. Although not shown, in the structure (FC2) in which the two fuel cells Cell have been connected in series, a plurality of structures (FC2) can be disposed in parallel between the metal substrate layers (MS1, MS2, MS3) adjacent in the Z direction as in the modification (FIG. 15) of the second embodiment as the present embodiment in which the parallel connections FC1 have been connected in parallel in the Y direction.

Also, in the fuel cell stack according to the modification of the second embodiment as the present embodiment, similarly to the case shown in FIGS. 8 and 9, it is possible to obtain the effect of reducing the thicknesses in the Z direction of the flow path of the fuel gas Fuel, the flow path of the air Air, and the structure for one layer of the fuel cell Cell. In addition, similarly to the fuel cell stack in FIGS. 14 and 15, the cell group CG includes a plurality of fuel cells Cell, and the effect is that the output of the stack can be easily improved with a small number of stacked cells. Compared to the fuel cell stacks in FIGS. 14 and 15, since the fuel cells Cell with the cathode layers 10 facing each other are connected in series between the adjacent metal substrate layers (MS1, MS2, MS3), the output voltage can be increased, and the current can be reduced, so that a power loss due to parasitic resistance can be easily prevented.

### Third Embodiment

In the fuel cell stack of the second embodiment, the fuel cells Cell included in the same cell group CG, that is, the fuel cells Cell at the same altitude (position in the Z direction) have been connected in parallel between the metal substrate layers (MS1, MS2, MS3), but a plurality of fuel cells Cell can be connected in series in the plane as in a third embodiment.

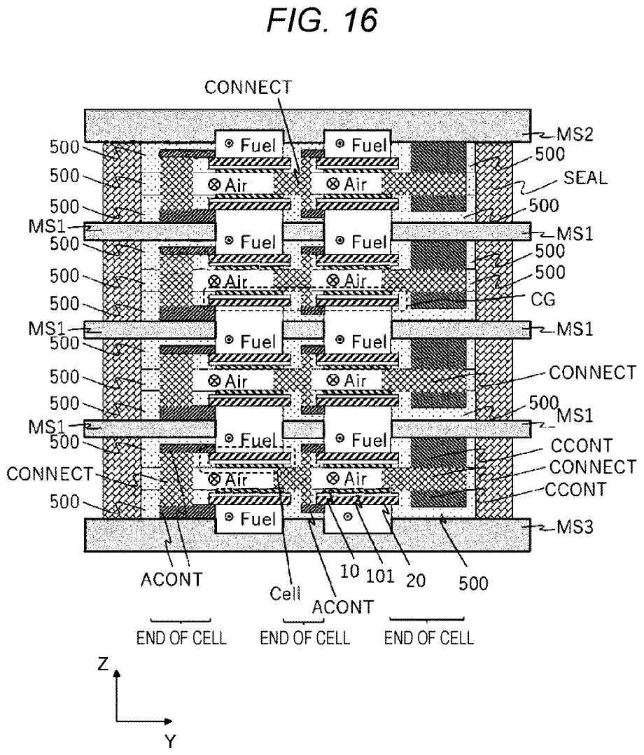

FIG. 16 is an example of a fuel cell stack according to the third embodiment as the present embodiment in which the cell group CG is formed of two fuel cells Cell, and shows a cross-sectional view taken along the Y-Z plane. The cross-sections of the X-Z plane are similar to those of FIGS. 2 and 3, and the description thereof is thus omitted.

The electrical connection between the fuel cells Cell shown in FIG. 16 will be described. The mechanical configuration and electrical connection of the fuel cells Cell and the metal substrate layers MS1 to MS3 are basically similar to those described with reference to FIG. 4. The different parts will be described below.

In an area where the metal substrate layer MS3 and the metal substrate layer MS1 face each other, two each of four fuel cells Cell are disposed with the cathode layers 10 facing each other. The anode layers 20 of the two fuel cells Cell are electrically connected at the connection portion CONNECT via the anode contact ACONT at the left end of the left fuel cell Cell of FIG. 16 and are also electrically connected to the metal substrate layer MS3.

The two cathode layers 10 of the fuel cells Cell are electrically connected to each other at the connection portion CONNECT at the right end of the left fuel cell Cell of FIG. 16 and are connected to the anode layer 20 of the right fuel cell Cell via the anode contact ACONT. The two cathode layers 10 of the fuel cells Cell are electrically connected to each other at the connection portion CONNECT at the right end of the right fuel cell Cell of FIG. 16 and are connected to the metal substrate layer MS1 via the cathode contact CCONT.

Also, in an area where two metal substrate layers MS1 adjacent in the Z direction face each other and an area where the metal substrate layer MS1 and the metal substrate layer MS2 face each other, two each of four fuel cells Cell are disposed with the cathode layers 10 facing each other. The electrical connection is similar to the four fuel cells Cell disposed between the metal substrate layer MS3 and the metal substrate layer MS1.

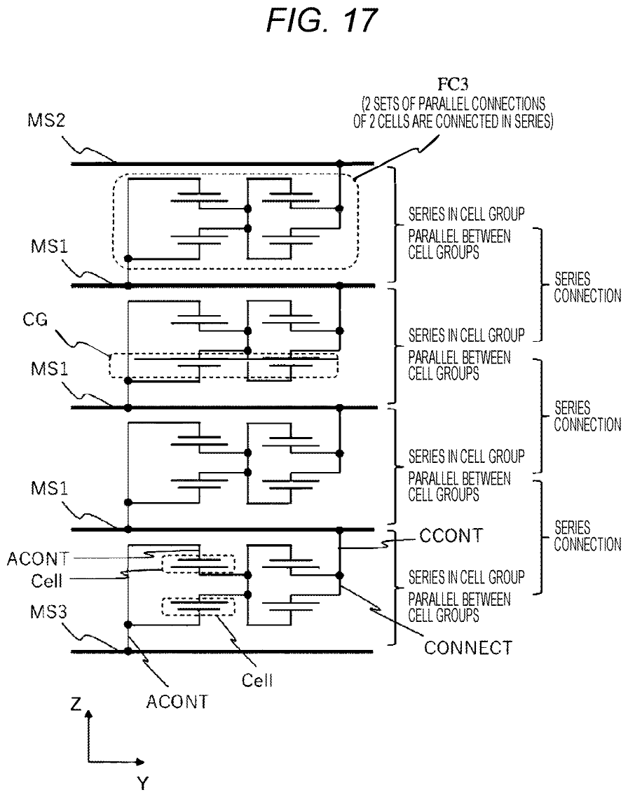

FIG. 17 shows the equivalent circuit diagram of the fuel cell stack shown in FIG. 16. Two each of four fuel cells Cell disposed between the metal substrate layer MS3 and the metal substrate layer MS1 are disposed with the cathode layers 10 (positive electrodes) facing each other. The metal substrate layer MS3 is connected to the anode layers 20 (negative electrodes) of two left fuel cells Cell, and the metal substrate layer MS1 is connected to the cathode layers 10 (positive electrodes) of two right fuel cells Cell. At a boundary portion between the two left fuel cells Cell and the two right fuel cells Cell, the cathodes of the two left fuel cells Cell are connected to the anodes of the two right fuel cells Cell. This results in a structure (FC3 in FIG. 17) in which two sets of parallel connections of two fuel cells Cell are connected in series.

Similarly, the structure (FC3) in which two sets of parallel connections of two fuel cells Cell are connected in series is formed between two metal substrate layers MS1 adjacent in the Z direction and between the metal substrate layer MS1 and the metal substrate layer MS2. In FIGS. 16 and 17, the number of fuel cells Cell in the series connection direction has been two in FC3 formed in the boundary area between the adjacent metal substrate layers (MS1, MS2, MS3). However, it is naturally possible to set the number of fuel cells Cell included in the cell group CG to three or more, and connect three or more sets of parallel connections of two cells Cell in series.

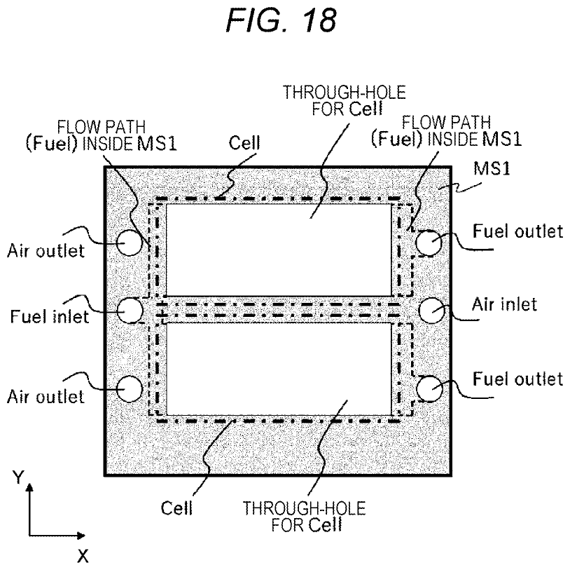

FIG. 18 shows a plan view of the metal substrate layer MS1 for realizing the fuel cell stack structure of FIGS. 16 to 17. Differences from the example of FIG. 6 will be described.

In the center of the metal substrate layer MS1, a through-hole for the fuel cell Cell is open at a place where the fuel cell Cell is disposed. Since the number of fuel cells Cell included in the cell group CG is two, two through-holes for the fuel cells Cell extending in the X direction are formed side by side in the Y direction, reflecting the fact that one fuel cell Cell is formed each on the left and right in each layer in the cross section of FIG. 16. Also, when three or more fuel cells Cell are included in the cell group CG, the same number of through-holes as the fuel cells Cell included in the cell group CG can be arranged in the Y direction.

The two through-holes for the fuel cells Cell are each connected from the inlet Fuel Inlet of the fuel gas Fuel and the outlet Fuel Outlet of the fuel gas Fuel by a flow path (Fuel) formed inside the metal substrate layer MS1. Thanks to this flow path (Fuel), the fuel gas Fuel can be supplied from the inlet Fuel Inlet of the fuel gas Fuel to the anode layer 20 of the fuel cell Cell when the fuel cell stack is formed, and unreacted gas, water vapor, and the like can be discharged from the outlet Fuel Outlet of the fuel gas Fuel.

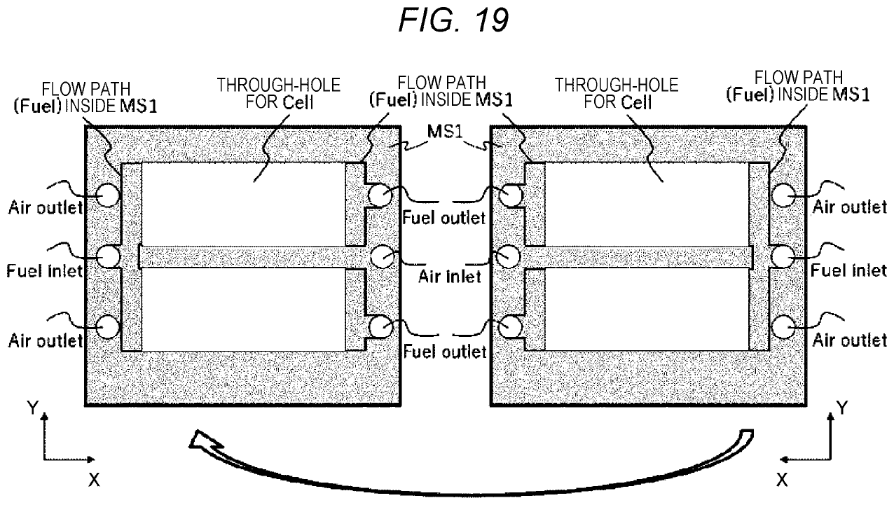

FIG. 19 is a plan view for explaining a preparation example of the metal substrate layer MS1 in FIG. 18. As in the case described with reference to FIG. 7, the metal substrate layers are structured to be line-symmetrical, thus facilitating the promotion of cost reduction during mass production.

Also, in the fuel cell stack of the third embodiment shown in FIGS. 16 and 17, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In addition, unlike the fuel cell stack according to the first embodiment, the cell group CG includes a plurality of fuel cells Cell, and the effect is that the output of the stack can be easily improved with a small number of stacked cells. Compared to the second embodiment, the cells between the adjacent metal substrate layers (MS1, MS2, MS3) are connected in series, making it easier to suppress a power loss due to parasitic resistance by increasing the output voltage and reducing the current.

In FIGS. 16 and 17, one FC3 has been formed in each area between the adjacent metal substrate layers (MS1, MS2, MS3), but a plurality of FC3 connected in parallel can be formed in each area between the adjacent metal substrate layers (MS1, MS2, MS3).

### Third Embodiment: First Modification

In the fuel cell stacks in FIGS. 16 and 17, the structure (FC3) in which two sets of parallel connections of two cells Cell have been connected in series, formed between adjacent metal substrate layers (MS1, MS2, MS3), are electrically connected to the lower metal substrate layer at the left end and are electrically connected to the upper metal substrate layer at the right end between all the metal substrate layers (MS1, MS2, MS3). However, as in a first modification as the present modification, it is possible to alternately swap the connection portions between the metal substrate layer and the fuel cell Cell.

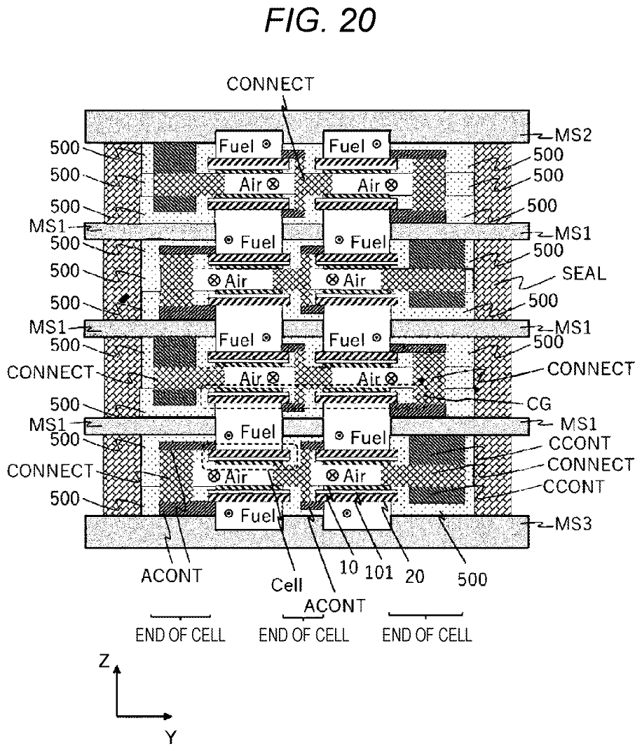

FIG. 20 is the first modification of the fuel cell stack according to the third embodiment as the present embodiment in which the cell group CG is formed of two fuel cells Cell, and shows a cross-sectional view taken along the Y-Z plane. The cross-sections of the X-Z plane are similar to those of FIGS. 2 and 3, and the description thereof is thus omitted.

The electrical connection between the fuel cells Cell shown in FIG. 20 will be described. The mechanical configuration and electrical connection of the fuel cells Cell and the metal substrate layers MS1 to MS3 are basically similar to those described with reference to FIG. 4. The different parts will be described below.

In an area where the metal substrate layer MS3 and the metal substrate layer MS1 face each other, two each of four fuel cells Cell are disposed with the cathode layers 10 facing each other. The anode layers 20 of the two fuel cells Cell are electrically connected at the connection portion CONNECT via the anode contact ACONT at the left end of the left fuel cell Cell of FIG. 20 and are also electrically connected to the metal substrate layer MS3.

The two cathode layers 10 of the fuel cells Cell are electrically connected to each other at the connection portion CONNECT at the right end of the left fuel cell Cell of FIG. 20 and are connected to the anode layer 20 of the right fuel cell Cell via the anode contact ACONT. The two cathode layers 10 of the fuel cells Cell are electrically connected to each other at the connection portion CONNECT at the right end of the right fuel cell Cell of FIG. 20 and are connected to the metal substrate layer MS1 via the cathode contact CCONT.

Also, between the lowermost metal substrate layer MS1 and the second metal substrate layer MS1 from the bottom among three metal substrate layers MS1 formed in FIG. 20, two each of the four fuel cells Cell are disposed with the cathode layers 10 facing each other. The anode layers 20 of the two fuel cells Cell are electrically connected to each other at the connection portion CONNECT via the anode contact ACONT at the right end of the right fuel cell Cell of FIG. 20 and are also electrically connected to the lowermost metal substrate layer MS1 among the three metal substrate layers MS1 formed. The two cathode layers 10 of the fuel cells Cell are electrically connected to each other at the connection portion CONNECT at the left end of the right fuel cell Cell in FIG. 20 and are connected to the anode layer 20 of the left fuel cell Cell via the anode contact ACONT. The two cathode layers 10 of the fuel cells Cell are electrically connected to each other at the connection portion CONNECT at the left end of the left fuel cell Cell of FIG. 20 and are connected to the second metal substrate layer MS1 from the bottom among the three metal substrate layers MS1 formed via the cathode contact CCONT.

Also between the second metal substrate layer MS1 from the bottom and the uppermost metal substrate layer MS1 among the three metal substrate layers MS1 formed in FIG. 20, two each of the four fuel cells Cell are disposed with the cathode layers 10 facing each other. The anode layers 20 of the two fuel cells Cell are electrically connected at the connection portion CONNECT via the anode contact ACONT at the left end of the left fuel cell Cell of FIG. 20 and are also electrically connected to the second metal substrate layer MS1 from the bottom among the three metal substrate layers MS1 formed. The two cathode layers 10 of the fuel cells Cell are electrically connected to each other at the connection portion CONNECT at the right end of the left fuel cell Cell of FIG. 20 and are connected to the anode layer 20 of the right fuel cell Cell via the anode contact ACONT. The two cathode layers 10 of the fuel cells Cell are electrically connected to each other at the connection portion CONNECT at the right end of the right fuel cell Cell of FIG. 20 and are connected to the uppermost metal substrate layer MS1 among the three metal substrate layers MS1 formed via the cathode contact CCONT.

Also between the uppermost metal substrate layer MS1 and the metal substrate layer MS2 among the three metal substrate layers MS1 formed in FIG. 20, two each of the four fuel cells Cell are disposed with the cathode layers 10 facing each other. The anode layers 20 of the two fuel cells Cell are electrically connected to each other at the connection portion CONNECT via the anode contact ACONT at the right end of the right fuel cell Cell of FIG. 20 and are also electrically connected to the uppermost metal substrate layer MS1 among the three metal substrate layers MS1 formed. The two cathode layers 10 of the fuel cells Cell are electrically connected to each other at the connection portion CONNECT at the left end of the right fuel cell Cell in FIG. 20 and are connected to the anode layer 20 of the left fuel cell Cell via the anode contact ACONT. The two cathode layers 10 of the fuel cells Cell are electrically connected to each other at the connection portion CONNECT at the left end of the left fuel cell Cell of FIG. 20 and are connected to the metal substrate layer MS2 via the cathode contact CCONT.

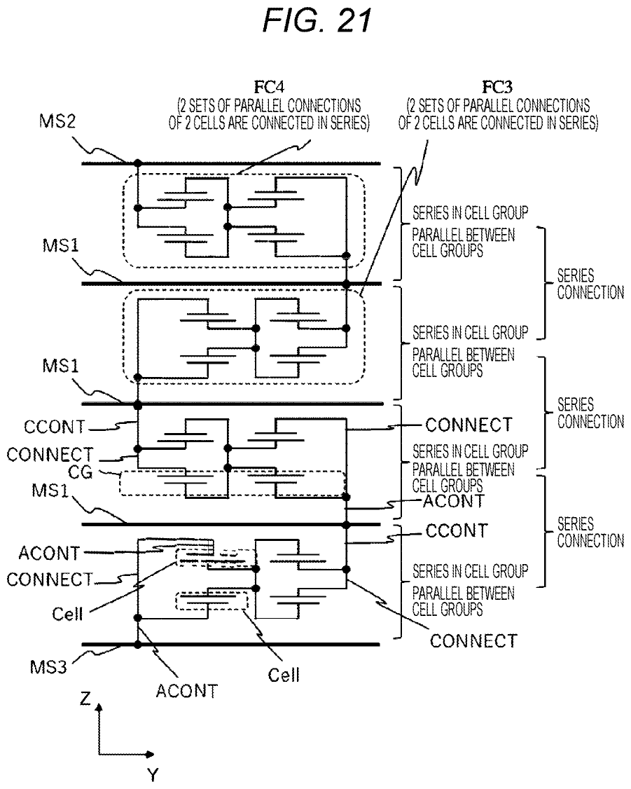

FIG. 21 shows the equivalent circuit diagram of the fuel cell stack shown in FIG. 20. Two each of four fuel cells Cell disposed between the metal substrate layer MS3 and the metal substrate layer MS1 are disposed with the cathode layers 10 (positive electrodes) facing each other. The metal substrate layer MS3 is connected to the anode layers 20 (negative electrodes) of two left fuel cells Cell, and the metal substrate layer MS1 is connected to the cathode layers 10 (positive electrodes) of two right fuel cells Cell. At a boundary portion between the two left fuel cells Cell and the two right fuel cells Cell, the cathodes of the two left fuel cells Cell are connected to the anodes of the two right fuel cells Cell. This results in a structure (FC3) in which two sets of parallel connections of two cells Cell are connected in series.

At the boundary between the lowermost metal substrate layer MS1 and the second metal substrate layer MS1 from the bottom among the three metal substrate layers MS1 formed, structures in which two sets of parallel connections of two cells Cell are connected in series are connected to the lower metal substrate layer MS1 at the right end and connected to the upper metal substrate layer MS1 at the left end (FC4).

At the boundary between the second metal substrate layer MS1 from the bottom and the uppermost metal substrate layer MS1 among the three metal substrate layers MS1 formed, structures in which two sets of parallel connections of two cells Cell are connected in series are connected to the lower metal substrate layer MS1 at the left end and connected to the upper metal substrate layer MS1 at the right end (FC3).

At the boundary between the uppermost metal substrate layer MS1 and the metal substrate layer MS2 among the three metal substrate layers MS1 formed, structures in which two sets of parallel connections of two cells Cell are connected in series are connected to the lower metal substrate layer MS1 at the right end and connected to the upper metal substrate layer MS1 at the left end (FC4).

In the structure of FIGS. 16 and 17, the cathode of the fuel cell Cell on the lower side of each metal substrate layer MS1 is taken out to the right end of the metal substrate layer MS1, and the anode of the fuel cell Cell on the upper side of each metal substrate layer MS1 is taken out to the left end of the metal substrate layer MS1. For this reason, a power loss due to a voltage drop in the metal substrate layer MS1 may occur because the current flows from the right end to the left end of the metal substrate layer MS1 during power generation.

On the other hand, in the structure of FIGS. 20 and 21, when the cathode of the fuel cell Cell on the lower side of the metal substrate layer MS1 is taken out to the right end of the metal substrate layer MS1, the anode of the fuel cell Cell on the upper side of the metal substrate layer MS1 is taken out to the right end of the metal substrate layer MS1, and when the cathode of the fuel cell Cell on the lower side of the metal substrate layer MS1 is taken out to the left end of the metal substrate layer MS1, the anode of the fuel cell Cell on the upper side of the metal substrate layer MS1 is taken out to the left end of the metal substrate layer MS1. Hence it is possible to suppress a power loss due to a voltage drop in the metal substrate layer MS1 during power generation.

The structure of FIGS. 16 and 17 has some advantages over the structure of FIGS. 20 and 21. At the time of mounting the cells on the metal substrate layer MS1 of FIG. 19, the cells are electrically connected side by side at the positions of the through-holes for the cells Cell. At this time, in the structure of FIGS. 16 and 17, the same connection method can be used for the front and back of the metal substrate layer MS1. In fact, no matter which cell group CG is focused on, the fuel cell Cells are connected in series within the cell group CG so that the potential increases along the direction of increasing Y-coordinate.

On the other hand, in the structure of FIGS. 20 and 21, the fuel cells Cell are connected in series in the cell group CG so that the potential increases in the increasing direction of the Y coordinate in the area between the metal substrate layers MS3 and the lowermost metal substrate layer MS1 among the three metal substrate layers MS1 formed, but the fuel cells Cell are connected in series in the cell group CG so that the potential increases in the decreasing direction of the Y coordinate in the area between the lowermost metal substrate layer MS1 and the second MS1 from the bottom among the three metal substrate layers MS1 formed. That is, in the structure of FIGS. 16 and 17, the fuel cells Cell can be connected in series in the same manner in all the cell groups CG, whereas in FIGS. 20 and 21, it is necessary to reverse the direction of the series connection for each cell group CG. The structure of FIGS. 16 and 17 makes it easier to reduce the manufacturing cost of the fuel cell stack, and the structure in FIGS. 20 and 21 makes it easier to suppress a power loss and reduce the running cost of the fuel cell stack.

Also, in the first modification as the present modification, it is naturally possible to set the number of fuel cells Cell included in the cell group CG to three or more, and connect three or more sets of parallel connections of two cells Cell in series.

Also, in the fuel cell stack of the first modification of the third embodiment shown in FIGS. 20 and 21, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In addition, unlike the fuel cell stack according to the first embodiment, the cell group CG includes a plurality of fuel cells Cell, and the effect is that the output of the stack can be easily improved with a small number of stacked cells. Compared to the second embodiment, the cells between the adjacent metal substrate layers (MS1, MS2, MS3) are connected in series, making it easier to suppress a power loss due to parasitic resistance by increasing the output voltage and reducing the current.

In FIGS. 20 and 21, one FC3 or FC4 has been formed in each area between the adjacent metal substrate layers (MS1, MS2, MS3), but a plurality of FC3 or FC4 connected in parallel can be formed in each area between the adjacent metal substrate layers (MS1, MS2, MS3).

### Third Embodiment: Second Modification

In the fuel cell stack in FIGS. 16 and 17 and the fuel cell stack in FIGS. 20 and 21, the structures in each of which two sets of parallel connections of two cells Cell are connected in series, formed between the adjacent metal substrate layers (MS1, MS2, MS3), are formed between all the metal substrate layers (MS1, MS2, MS3). However, as in a second modification as the present modification, the fuel cells Cell formed between the adjacent metal substrate layers (MS1, MS2, MS3) may be connected in series also in the cell group CG, and the cathode layers 10 may be connected in series also between the cells facing each other.

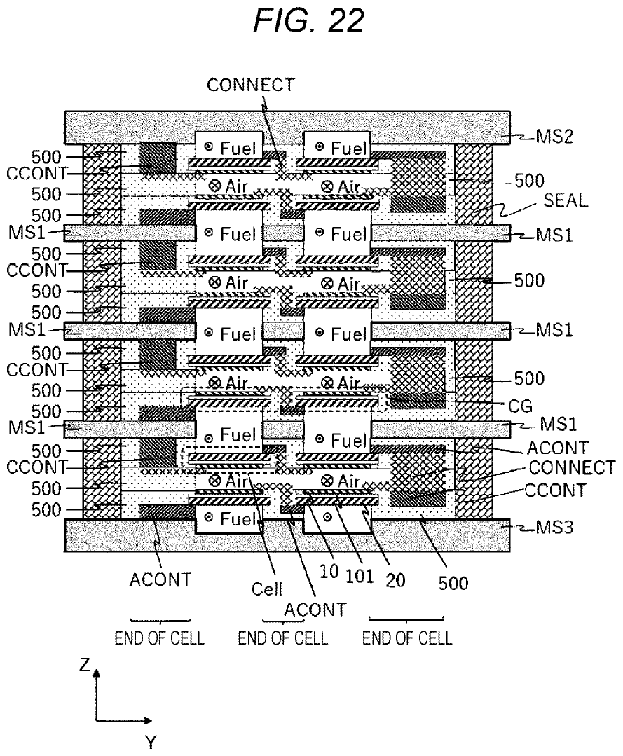

FIG. 22 is the third modification of the fuel cell stack according to the second embodiment as the present embodiment in which the cell group CG is formed of two fuel cells Cell, and shows a cross-sectional view taken along the Y-Z plane. The cross-sections of the X-Z plane are similar to those of FIGS. 2 and 3, and the description thereof is thus omitted.

The electrical connection between the fuel cells Cell shown in FIG. 22 will be described. The mechanical configuration and electrical connection of the fuel cells Cell and the metal substrate layers MS1 to MS3 are basically similar to those described with reference to FIG. 4. The different parts will be described below.

In an area where the metal substrate layer MS3 and the metal substrate layer MS1 face each other, two each of four fuel cells Cell are disposed with the cathode layers 10 facing each other. The anode layer 20 of the lower fuel cell Cell is electrically connected to the metal substrate layer MS3 via the anode contact ACONT at the left end of the left fuel cell Cell of FIG. 22. The cathode layer 10 of the lower fuel cell Cell is connected to the anode contact ACONT of the right lower fuel cell Cell via the connection portion CONNECT at the right end of the left fuel cell Cell in FIG. 22, and further connected to the anode layer 20 of the right lower fuel cell Cell.

The cathode layer 10 of the lower fuel cell Cell is connected to the anode contact ACONT of the right upper fuel cell Cell via the connection portion CONNECT at the right end of the right lower fuel cell Cell in FIG. 22, and further connected to the anode layer 20 of the right upper fuel cell Cell. The cathode layer 10 of the right upper fuel cell Cell is connected to the anode contact ACONT of the left upper fuel cell Cell via the connection portion CONNECT and is further connected to the anode layer 20 of the left upper fuel cell Cell. The cathode layer 10 of the upper left fuel cell Cell is connected to the metal substrate layer MS1 via the connection portion CONNECT and the cathode contact CCONT.

Also, in the area between two adjacent metal substrate layers MS1 and the area between the metal substrate layer MS1 and the metal substrate layer MS3 in FIG. 22, two each of the four fuel cells Cell are disposed with the cathode layers 10 facing each other. The connection between the four fuel cells Cell is similar to that in the area where the metal substrate layer MS3 and the metal substrate layer MS1 face each other.

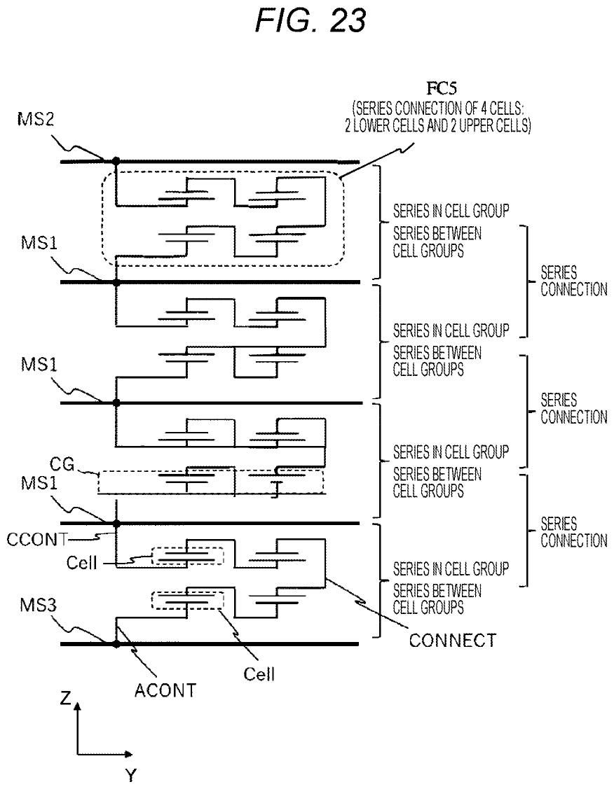

FIG. 23 shows the equivalent circuit diagram of the fuel cell stack shown in FIG. 22. Two each of four fuel cells Cell disposed between the metal substrate layer MS3 and the metal substrate layer MS1 are disposed with the cathode layers 10 (positive electrodes) facing each other. The metal substrate layer MS3 is connected to the anode layers 20 (negative electrodes) of two left fuel cells Cell, and the metal substrate layer MS1 is connected to the cathode layers 10 (positive electrodes) of two right fuel cells Cell. At a boundary portion between the two left fuel cells Cell and the two right fuel cells Cell, the cathodes of the two left fuel cells Cell are connected to the anodes of the two right fuel cells Cell. This results in a structure (FC5) in which a total of four fuel cells Cell, which are two lower fuel cells Cell and two upper fuel cells Cell, are connected in series. Similarly, between two metal substrate layers MS1 adjacent in the Z direction and between the metal substrate layer MS1 and the metal substrate layer MS2, a structure (FC5) is formed in which a total of four fuel cells Cell, which are two lower fuel cells Cell and two upper fuel cells Cell, are connected in series.

In the structure of FIGS. 22 and 23, the cathode of the fuel cell Cell on the lower side of the metal substrate layer MS1 is taken out to the left end of the metal substrate layer MS1, and the anode of the fuel cell Cell on the upper side of the metal substrate layer MS1 is also taken out to the left end of the metal substrate layer MS1. Hence it is possible to suppress a power loss due to a voltage drop in the metal substrate layer MS1 during power generation.

Also, in the second modification as the present modification, it is naturally possible to set the number of fuel cells Cell included in the cell group CG to three or more and to set the FC5 to a series connection structure of six or more.

Also, in the fuel cell stack of the second modification of the third embodiment shown in FIGS. 22 and 23, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In addition, unlike the fuel cell stack according to the first embodiment, the cell group CG includes a plurality of fuel cells Cell, and the effect is that the output of the stack can be easily improved with a small number of stacked cells. Compared to the structure of FIGS. 16 and 17 and the structure of FIGS. 20 and 21, the number of series connections of the fuel cells Cell between the adjacent metal substrate layers (MS1, MS2, MS3) increases, making it easier to suppress a power loss due to parasitic resistance by increasing the output voltage and reducing the current.

In FIGS. 22 and 23, one FC5 has been formed in each area between the adjacent metal substrate layers (MS1, MS2, MS3), but a plurality of FC5 connected in parallel can be formed in each area between the adjacent metal substrate layers (MS1, MS2, MS3).

### Fourth Embodiment

In the first to third embodiments, the rectangular metal substrate layers (MS1, MS2, MS3) and the rectangular fuel cells Cell have been used, but as in a fourth embodiment, circular metal substrate layers (MS1, MS2, MS3) and ring-shaped fuel cells Cell can also be used.

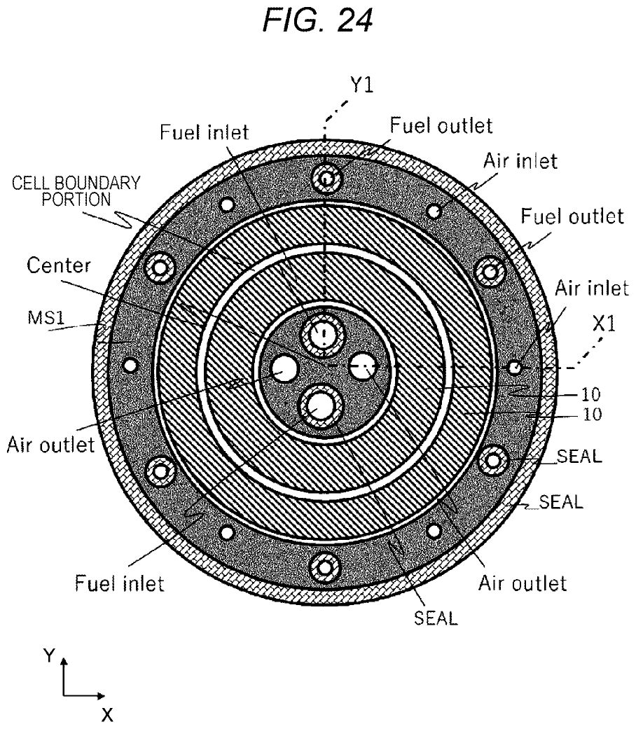

FIG. 24 is an X-Y plan view showing a part of a fuel cell stack of the fourth embodiment as the present embodiment. Two fuel cells Cell are disposed on the metal substrate layer MS1, and each cathode layer 10 is shown in FIG. 24. The two fuel cells Cell have different shapes, with the inner diameter of the outer fuel cell Cell being larger than the outer diameter of the inner fuel cell Cell, and are disposed around the same position. The outer fuel cell Cell is included in the outer diameter of the metal substrate layer MS1.

Four through-holes are formed in the metal substrate layer MS1 on the center side of the inner diameter of the inner cell. Two of these are outlets Air Outlet of the air Air, and the other two are inlets Fuel Inlet of the fuel gas Fuel. Further, inlets Air Inlet of the air Air and outlets Fuel Outlet of the fuel gas Fuel are formed slightly inside along the outer edge of the metal substrate layer MS1 outside the outer diameter of the outer cell. A sealing material SEAL is formed at the edge of the inlet Fuel Inlet of the fuel gas Fuel, the edge of the outlet Fuel Outlet of the fuel gas Fuel, and the outermost edge of the metal substrate layer MS1. The sealing material SEAL is electrically an insulator as described above.

In the metal substrate layer MS1, a through-hole for the fuel cell Cell is open in an area where the fuel cell Cell is formed, a flow path of the fuel gas Fuel is formed inside the metal substrate layer MS1 between the inlet Fuel Inlet and the outlet Fuel Outlet of the fuel gas Fuel and the through-hole for the fuel cell Cell, the metal substrate layer MS1 can be formed using two metal substrate layers by welding, and the like are the same as in the case of the rectangular metal substrate layer MS1 in FIGS. 18 and 19.

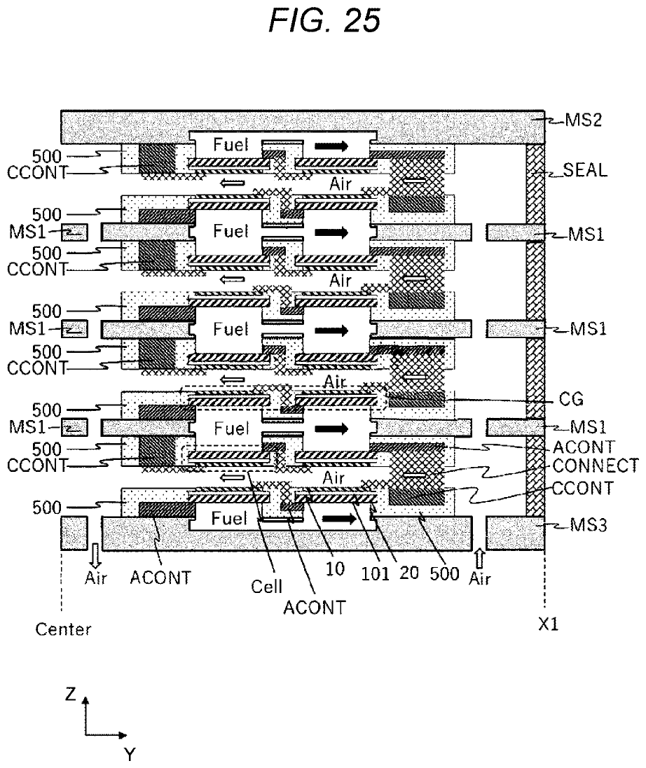

FIG. 25 is a cross-sectional view taken along a plane perpendicular to the paper surface along the outer edge Xl from a center portion Center in FIG. 24. FIG. 25 is a cross-sectional view taken along a flow path of the air Air. As the metal substrate layers, the lowermost metal substrate layer MS3, a plurality of the metal substrate layers MS1, and the uppermost metal substrate layer MS2 are stacked, and in the area between adjacent metal substrate layers, the outer fuel cells Cell are disposed and the inner fuel cells Cell are disposed with the cathode layers 10 facing each other.

The air Air is supplied from the outer edge of the lowermost metal substrate layer MS3 (the right side of FIG. 25) to an area where the cathode layers 10 face each other to form a flow path, and is discharged from the central portion of the lowermost metal substrate layer MS3 (the left side in FIG. 25). In the flow path of the air Air, the air Air needs to pass through the connection portion CONNECT by the route from the outer edge (the right side of FIG. 25) of the metal substrate layer MS3 to the area where the cathode layers 10 face each other to form the flow path. That is, the connection portion CONNECT needs to allow the air Air to pass therethrough. This can be realized, for example, by forming the connection portion CONNECT with a mesh-like electrode or intermittently forming a connection member along a direction perpendicular to the paper surface of FIG. 25 (a concentric direction of FIG. 24). Such a part is created because, unlike the fuel cell stacks of the first to third embodiments, the air Air and the fuel gas Fuel flow across a boundary portion between a plurality of fuel cells Cell formed in the cell group CG. The flow path of the air Air is shielded from the outside air by the sealing material SEAL and the metal substrate layer (MS1, MS2, MS3).

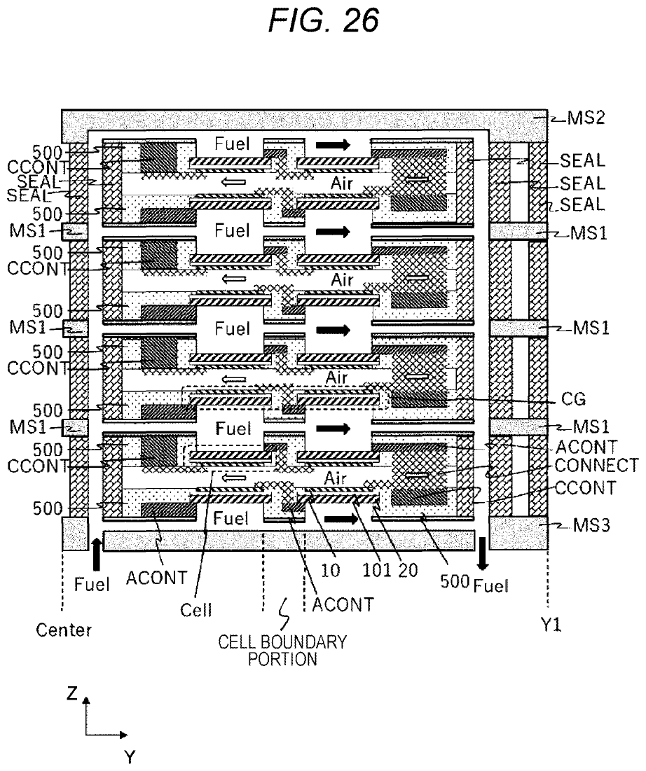

FIG. 26 is a cross-sectional view taken along a plane perpendicular to the paper surface along the outer edge Y1 from the center portion Center in FIG. 24. FIG. 26 is a cross-sectional view taken along the flow path of the fuel gas Fuel. The fuel gas Fuel is supplied from the center portion of the lowermost metal substrate layer MS3 (the left side of FIG. 26 through a flow path formed inside the metal substrate layer MS1 to an area where the anode layers 20 face each other to form a flow path, and is discharged from the outer edge of the lowermost metal substrate layer MS3 (the right side of FIG. 26). The flow path of the fuel gas Fuel is shielded from the outside air by the sealing material SEAL and the metal substrate layer (MS1, MS2, MS3). The flow path of the air Air and the flow path of the fuel gas Fuel are shielded from each other by the sealing material SEAL, the metal substrate layer (MS1, MS2, MS3), the fuel cell Cell, the anode contact ACONT, and the insulator layer 500.

In an area where the metal substrate layer MS3 and the metal substrate layer MS1 face each other, two each of four fuel cells Cell are disposed with the cathode layers 10 facing each other. The anode layer 20 of the lower fuel cell Cell on the inner side of FIG. 25 is electrically connected to the metal substrate layer MS3 via the anode contact ACONT. The cathode layer 10 of the lower fuel cell Cell is connected to the anode contact ACONT of the outer lower fuel cell Cell via the connection portion CONNECT at the right end of the inner fuel cell Cell in FIG. 25 and is further connected to the anode layer 20 of the outer lower fuel cell Cell. The cathode layer 10 of the fuel cell Cell is connected to the anode contact ACONT of the outer upper fuel cell Cell via the connection portion CONNECT at the outer end of the outer lower fuel cell Cell in FIG. 25 and is further connected to the anode layer 20 of the outer upper fuel cell Cell. The cathode layer 10 of the outer upper fuel cell Cell is connected to the anode contact ACONT of the inner upper fuel cell Cell via the connection portion CONNECT and is further connected to the anode layer 20 of the inner upper fuel cell Cell. The cathode layer 10 of the inner upper fuel cell Cell is connected to the metal substrate layer MS1 via the connection portion CONNECT and the cathode contact CCONT.

Also, in the area between two adjacent metal substrate layers MS1 and the area between the metal substrate layer MS1 and the metal substrate layer MS3 in FIG. 25, two each of the four fuel cells Cell are disposed with the cathode layers 10 facing each other. The connection between the four fuel cells Cell is similar to that in the area where the metal substrate layer MS3 and the metal substrate layer MS1 face each other. The equivalent circuit diagram of the fuel cell stack in FIGS. 24 to 26 is similar to that in FIG. 23, and hence the description thereof is omitted.

Also, in the fourth embodiment as the present embodiment, it is naturally possible to set the number of fuel cells Cell included in the cell group CG to three or more.

Also, in the fuel cell stack of the fourth embodiment shown in FIGS. 24 to 26, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In addition, unlike the fuel cell stack according to the first embodiment, the cell group CG includes a plurality of fuel cells Cell, and the effect is that the output of the stack can be easily improved with a small number of stacked cells. Compared to the structure of FIGS. 16 and 17 and the structure of FIGS. 20 and 21, the number of series connections of the fuel cells Cell between the adjacent metal substrate layers (MS1, MS2, MS3) increases, making it easier to suppress a power loss due to parasitic resistance by increasing the output voltage and reducing the current.

In FIGS. 24 to 26 of the fourth embodiment as the present embodiment, one structure of FC5 has been formed in the area between the adjacent metal substrate layers (MS1, MS2, MS3), but it is naturally possible to form the structure of FC1, FC2, FC3, or FC4. In addition, it is naturally possible to form not one but a plurality of each.

### Fourth Embodiment: Modification

Although the ring-shaped fuel cell Cell has been used in the fuel cell stack in FIGS. 24 to 26, a fuel cell Cell with a ring shape divided at two points in the concentric direction as in the present modification can also be used.

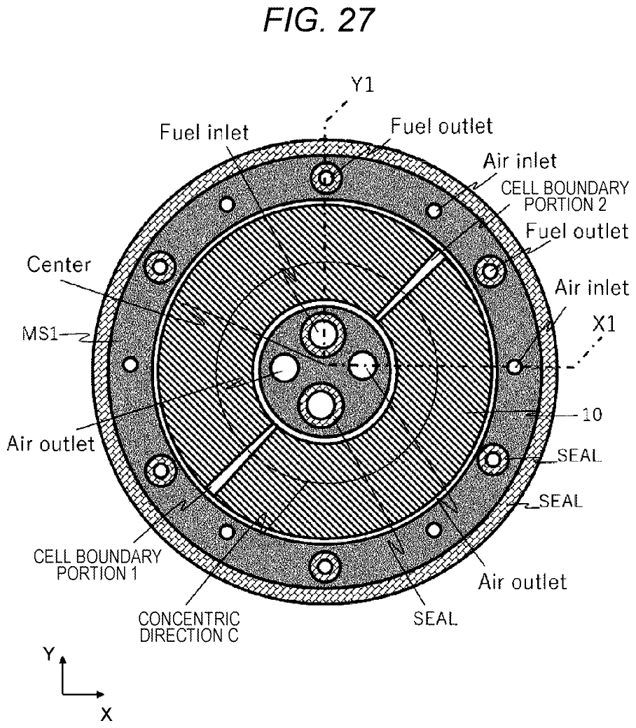

FIG. 27 is an X-Y plan view showing a part of a fuel cell stack according to a modification of the fourth embodiment as the present embodiment. Two fuel cells Cell are disposed on the metal substrate layer MS1, and each cathode layer 10 is shown in FIG. 27. The two fuel cells Cell have a ring shape divided at two points in the concentric direction. The two fuel cells Cell are included in the area of the metal substrate layer MS1.

Four through-holes are formed in an area near the center of the metal substrate layer MS1. Two of these are outlets Air Outlet of the air Air, and the other two are inlets Fuel Inlet of the fuel gas Fuel. Further, inlets Air Inlet of the air Air and outlets Fuel Outlets of the fuel gas Fuel are formed slightly inside along the outer edge of the metal substrate layer MS1. A sealing material SEAL is formed at the edge of the inlet Fuel Inlet of the fuel gas Fuel, the edge of the outlet Fuel Outlet of the fuel gas Fuel, and the outermost edge of the metal substrate layer MS1. The sealing material SEAL is electrically an insulator as described above.

In the metal substrate layer MS1, a through-hole for the fuel cell Cell is open in an area where the fuel cell Cell is formed, a flow path of the fuel gas Fuel is formed inside the metal substrate layer MS1 between the inlet Fuel Inlet and the outlet Fuel Outlet of the fuel gas Fuel and the through-hole for the fuel cell Cell, the metal substrate layer MS1 can be formed using two metal substrate layers by welding, and the like are the same as in the case of the rectangular metal substrate layer MS1 in FIGS. 18 and 19.

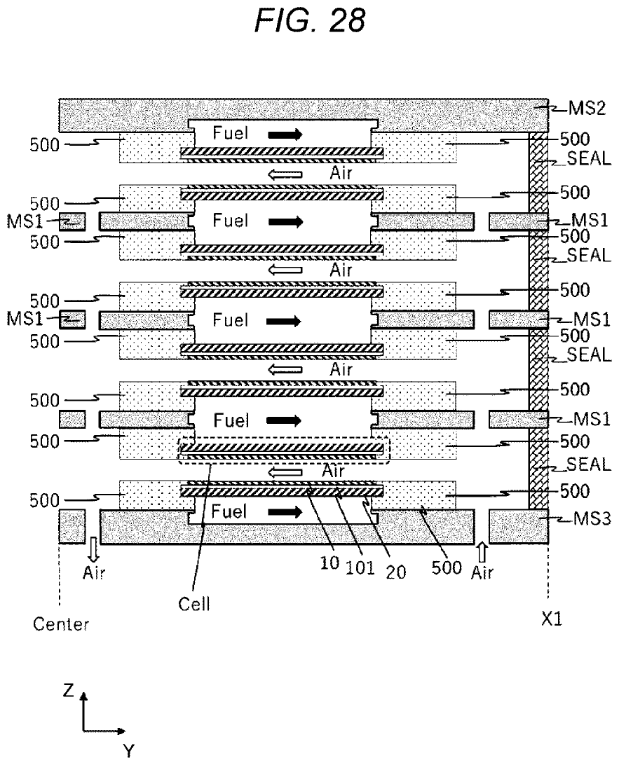

FIG. 28 is a cross-sectional view taken along a plane perpendicular to the paper surface along the outer edge Xl from a center portion Center in FIG. 27. FIG. 28 is a cross-sectional view taken along a flow path of the air Air. A state is shown where, as the metal substrate layers, the lowermost metal substrate layer MS3, a plurality of the metal substrate layers MS1, and the uppermost metal substrate layer MS2 are stacked, and in the area between adjacent metal substrate layers, two fuel cells Cell are disposed with the cathode layers 10 facing each other. In an area not shown in FIG. 28, two more fuel cells Cell are also disposed with the cathode layers 10 facing each other.

The air Air is supplied from the outer edge of the lowermost metal substrate layer MS3 (the right side in FIG. 28) to an area where the cathode layers 10 face each other to form a flow path, and is discharged from the central portion of the lowermost metal substrate layer MS3 (the left side in FIG. 28). Unlike the case of FIG. 25, the air Air does not to pass through the connection portion CONNECT by the flow path of the air Air. Unlike FIG. 25, there is no need for the air Air or the fuel gas Fuel to flow across a boundary portion between the plurality of fuel cells Cell formed in the cell group CG. The flow path of the air Air is shielded from the outside air by the sealing material SEAL and the metal substrate layer (MS1, MS2, MS3).

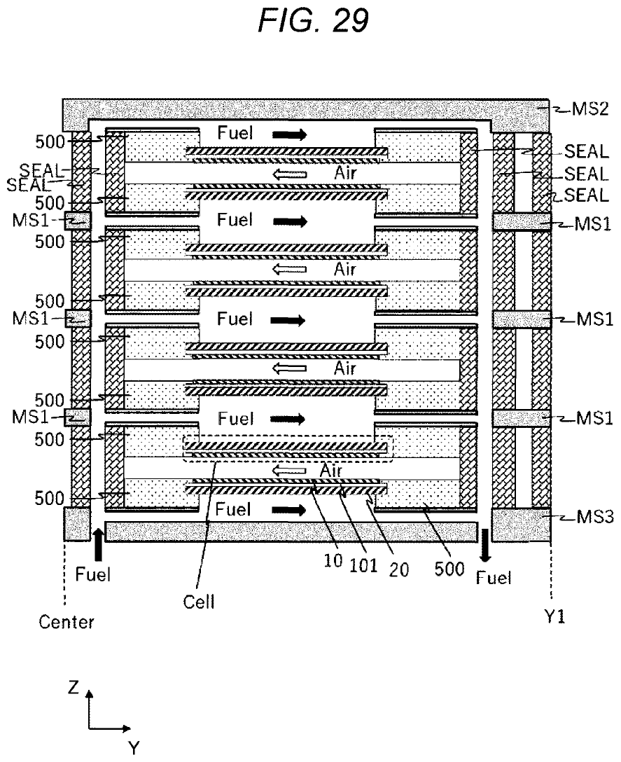

FIG. 29 is a cross-sectional view taken along a plane perpendicular to the paper surface along the outer edge Y1 from the center portion Center in FIG. 27. FIG. 29 is a cross-sectional view taken along the flow path of the fuel gas Fuel. The fuel gas Fuel is supplied from the center portion of the lowermost metal substrate layer MS3 (the left side of FIG. 29 through a flow path formed inside the metal substrate layer MS1 to an area where the anode layers 20 face each other to form a flow path, and is discharged from the outer edge of the lowermost metal substrate layer MS3 (the right side of FIG. 29). The flow path of the fuel gas Fuel is shielded from the outside air by the sealing material SEAL and the metal substrate layer (MS1, MS2, MS3). The flow path of the air Air and the flow path of the fuel gas Fuel are shielded from each other by the sealing material SEAL, the metal substrate layer (MS1, MS2, MS3), the fuel cell Cell, the anode contact ACONT, and the insulator layer 500.

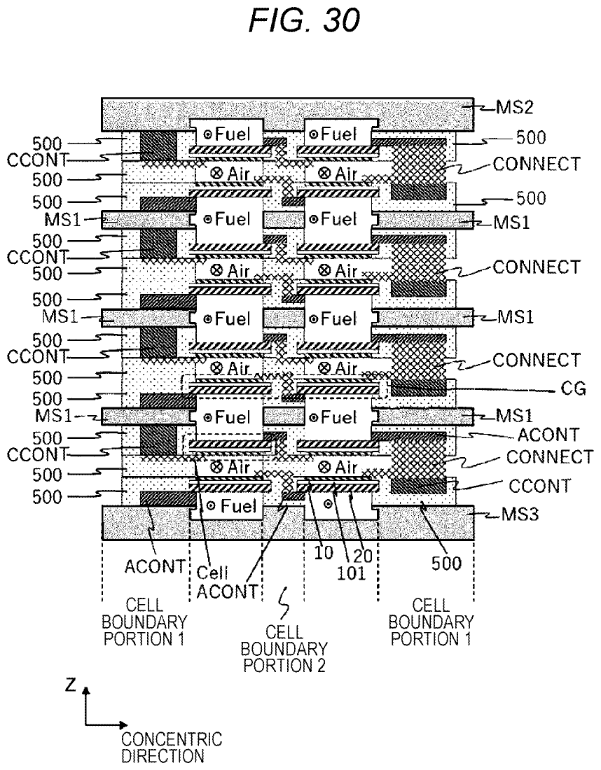

FIG. 30 is a cross-sectional view taken along a concentric circle C of FIG. 27 and taken along a plane perpendicular to the paper surface. In an area where the metal substrate layer MS3 and the metal substrate layer MS1 face each other, two each of four fuel cells Cell are disposed with the cathode layers 10 facing each other. The anode layer 20 of the lower left fuel cell Cell of FIG. 30 is electrically connected to the metal substrate layer MS3 via the anode contact ACONT. The cathode layer 10 of the lower fuel cell Cell is connected to the anode contact ACONT of the right lower fuel cell Cell via the connection portion CONNECT at the right end of the left fuel cell Cell in FIG. 30, and further connected to the anode layer 20 of the right lower fuel cell Cell. The cathode layer 10 of the lower fuel cell Cell is connected to the anode contact ACONT of the right upper fuel cell Cell via the connection portion CONNECT at the right end of the right lower fuel cell Cell in FIG. 30, and further connected to the anode layer 20 of the right upper fuel cell Cell. The cathode layer 10 of the right upper fuel cell Cell is connected to the anode contact ACONT of the left upper fuel cell Cell via the connection portion CONNECT and is further connected to the anode layer 20 of the left upper fuel cell Cell. The cathode layer 10 of the upper left fuel cell Cell is connected to the metal substrate layer MS1 via the connection portion CONNECT and the cathode contact CCONT.

Also, in the area between two adjacent metal substrate layers MS1 and the area between the metal substrate layer MS1 and the metal substrate layer MS3 in FIG. 30, two each of the four fuel cells Cell are disposed with the cathode layers 10 facing each other. The connection between the four fuel cells Cell is similar to that in the area where the metal substrate layer MS3 and the metal substrate layer MS1 face each other. The equivalent circuit diagram of the fuel cell stack in FIGS. 27 to 30 is similar to that in FIG. 23, and hence the description thereof is omitted.

Also, in the modification of the fourth embodiment as the present embodiment, it is naturally possible to set the number of fuel cells Cell included in the cell group CG to three or more, and connect three or more of the two cells Cell in parallel in series.

Also, in the fuel cell stack of the modification of the fourth embodiment shown in FIGS. 27 to 30, similarly to the case shown in FIGS. 8A and 8B and FIGS. 9A and 9B, it is possible to obtain the thicknesses in the Z direction of the flow path of the fuel gas Fuel, the flow path of the air Air, and the structure for one layer of the fuel cell Cell. In addition, unlike the fuel cell stack according to the first embodiment, the cell group CG includes a plurality of fuel cells Cell, and the effect is that the output of the stack can be easily improved with a small number of stacked cells. Compared to the structure of FIGS. 16 and 17 and the structure of FIGS. 20 and 21, the number of series connections of the fuel cells Cell between the adjacent metal substrate layers (MS1, MS2, MS3) increases, making it easier to suppress a power loss due to parasitic resistance by increasing the output voltage and reducing the current.

In FIGS. 27 to 30 of the modification of the fourth embodiment as the present embodiment, one structure of FC5 has been formed in the area between the adjacent metal substrate layers (MS1, MS2, MS3), but it is naturally possible to form the structure of FC1, FC2, FC3, or FC4. In addition, it is naturally possible to form not one but a plurality of each.

### Fifth Embodiment

In the fuel cell stack of the first to fourth embodiments, the connections including the series connections are continued from the lowermost layer to the uppermost layer in the stacking direction, but the fuel cell stack can be divided into a plurality of parts in the stacking direction as in a fifth embodiment as the present embodiment.

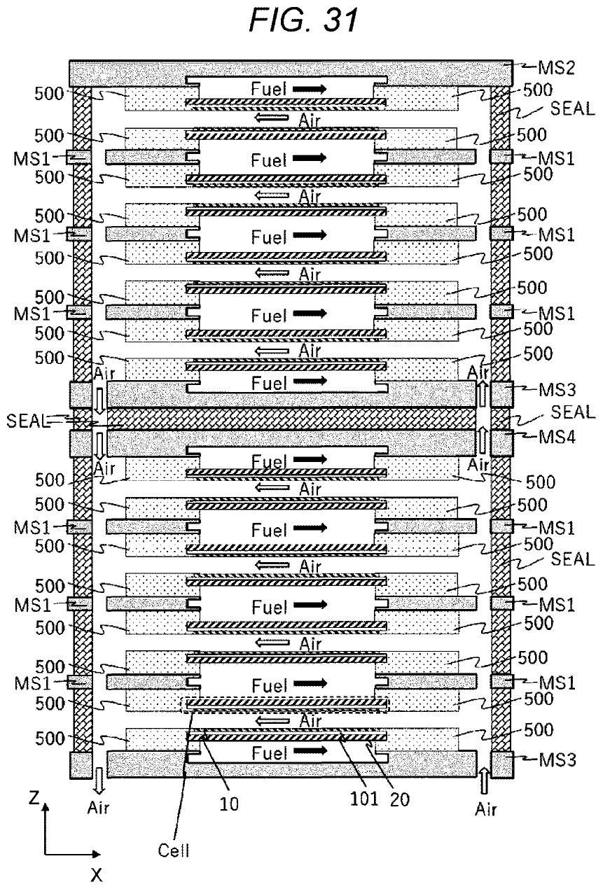

FIG. 31 shows a cross-sectional view of a fuel cell stack according to the fifth embodiment as the present embodiment taken along a flow path of the air Air along an X-Z plane. In the fuel cell stack in FIG. 31, the flow of the air Air is introduced from the right portion of the lowermost metal substrate layer MS3, supplied to the cathode layer 10 of each fuel cell, and discharged from the left portion of the lowermost metal substrate layer MS3. A part where a metal substrate layer MS4 and the metal substrate layer MS3 face each other via the sealing material SEAL is formed in the middle of the flow path of the air Air. This is a feature that the structure of the first to fourth embodiments does not have.

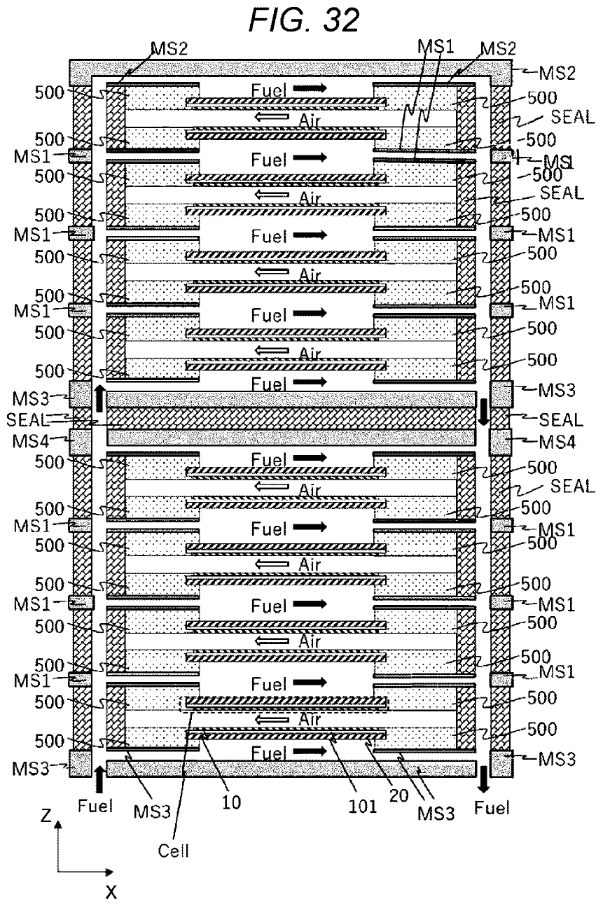

FIG. 32 shows a cross-sectional view of the fuel cell stack according to the fifth embodiment as the present embodiment taken along the X-Z plane along the fuel gas Fuel. In FIG. 32, the flow of the fuel gas Fuel is introduced from the left portion of the lowermost metal substrate layer MS3, supplied to the anode layer 20 of each fuel cell, and discharged from the right portion of the lowermost metal substrate layer MS3. A part where the metal substrate layer MS4 and the metal substrate layer MS3 face each other via the sealing material SEAL is formed in the middle of the flow path of the fuel gas Fuel. This is a feature that the structure of the first to fourth embodiments does not have.

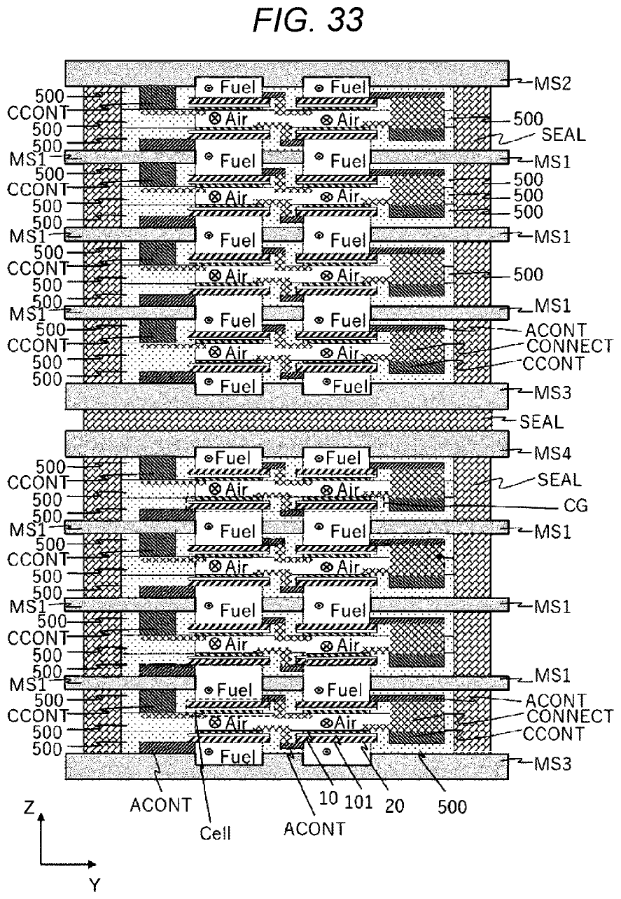

FIG. 33 shows a cross-sectional view of the fuel cell stack according to the fifth embodiment as the present embodiment taken along the Y-Z plane. The electrical connection between the fuel cells Cell in FIG. 33 will be described. As a major difference from the first to fourth embodiments, in the fuel cell stack in FIG. 33, a part from the lowermost metal substrate layer MS3 to the metal substrate layer MS4 and a part from the metal substrate layer MS3 to the metal substrate layer MS2 above the metal substrate layer MS4 are electrically separated by the sealing material SEAL. Focusing on each part, the electrical connection is similar to that of the second modification (FIGS. 22 and 23) of the third embodiment.

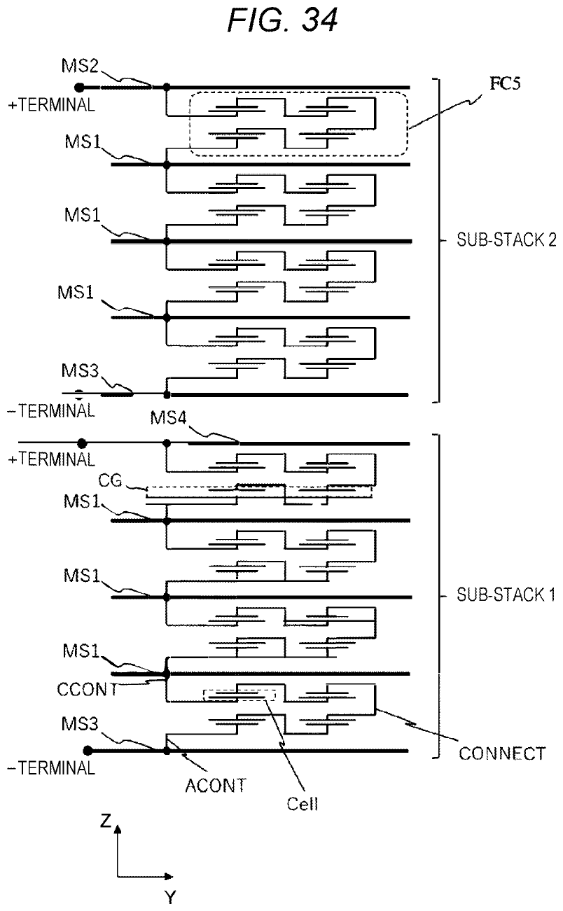

FIG. 34 shows the equivalent circuit diagram of the fuel cell stack shown in FIGS. 31 to 33. In the part (sub-stack 1) from the lowermost metal substrate layer MS3 to the metal substrate layer MS4, a structure (FC5) in which a total of four fuel cells Cell, which are two lower fuel cells Cell and two upper fuel cells Cell, are connected in series is formed in each boundary area between adjacent metal substrate layers (MS1, MS3, MS4).

In the part (sub-stack 2) from the metal substrate layer MS3 to the metal substrate layer MS2 above the metal substrate layer MS4, a structure (FC5) in which a total of four fuel cells Cell, which are two lower fuel cells Cell and two upper fuel cells Cell, are connected in series is formed in each boundary area between adjacent metal substrate layers (MS1, MS2, MS3). The metal substrate layer MS4 and the metal substrate layer MS3 above the metal substrate layer MS4 are insulated from each other. The sub-stack 1 and the sub-stack 2 can be connected in parallel to supply power to the outside.

Also, in the fuel cell stack of the fifth embodiment shown in FIGS. 31 to 34, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In cases such as a case where the voltage increases excessively when the entire stack is connected in series, and the withstand voltage between the output terminals of the stack cannot be sufficiently ensured, the method of the present embodiment can be used to reduce the output voltage, thereby suppressing a power loss due to an electrical short circuit failure or a leakage current.

In FIGS. 31 to 34, one FC5 has been formed in each area between adjacent metal substrate layers in the sub-stack, but it is also possible to form FC1, FC2, FC3, or FC4 between adjacent metal substrate layers in the sub-stack. It is also possible to connect a plurality of FC1, FC2, FC3, FC4, or FC5 in parallel to each other between adjacent metal substrate layers in the sub-stack.

As the shape of the metal substrate layer and the shape of the fuel cell Cell, a rectangular shape as in the first to third embodiments can be used, but as in the fourth embodiment, a circular metal substrate layer, a ring-shaped fuel cell Cell, and a fuel cell Cell having a shape obtained by dividing a ring shape in a concentric direction can also be used. In FIGS. 31 to 34, the number of sub-stacks has been two, but may be three or more.

### Fifth Embodiment: Modification

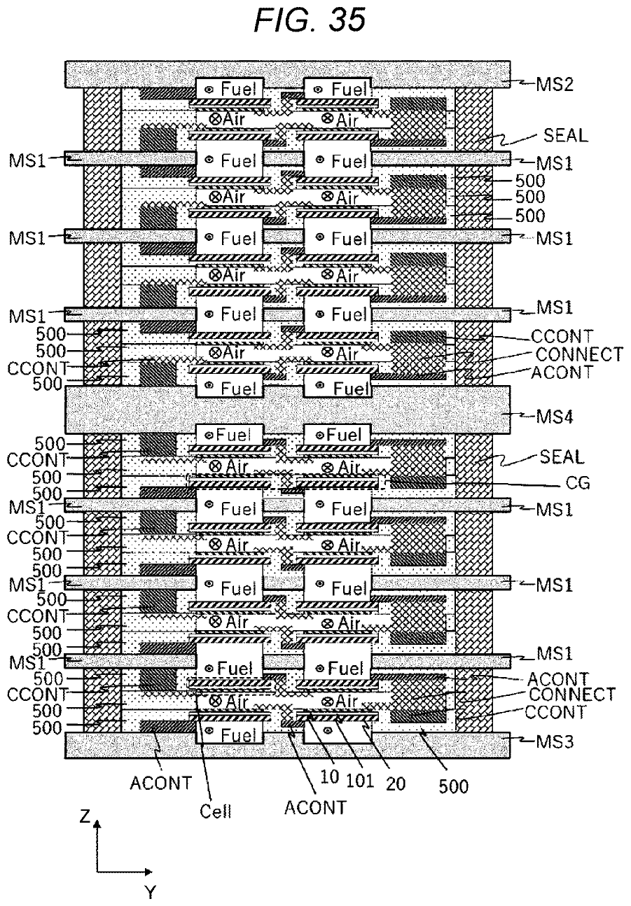

In the structure of FIGS. 31 to 34, the fuel cells Cell have been connected in series in both the sub-stack 1 and the sub-stack 2 in such a manner that the potential increases as the Z coordinate increases. However, as in the modification of the fifth embodiment as the present embodiment, in the sub-stack 1, the fuel cells Cell may be connected in series in a manner that the potential increases with the increase in the Z coordinate, and in the sub-stack 2, the fuel cells Cell may be connected in series in a manner that the potential decreases with the increase in the Z coordinate. With this connection, similarly to the structure of FIGS. 31 to 34, it is possible to share the metal substrate layer (MS4 of FIG. 35) at the boundary portion of the sub-stack while preventing the voltage from increasing excessively.

FIG. 35 shows a cross-sectional view of the fuel cell stack according to the modification of the fifth embodiment as the present embodiment taken along the Y-Z plane. The electrical connection between the fuel cells Cell in FIG. 35 will be described. Focusing on the sub-stack 1, the electrical connection is similar to that of the second modification (FIGS. 22 and 23) of the third embodiment. The structure between the metal substrate layers (MS1, MS2, MS4) of the sub-stack 2 is a structure vertically inverted with respect to the X-Y plane from the structure between the metal substrate layers (MS1, MS3, MS4) of the sub-stack 1. As a result, in the sub-stack 1, the fuel cells Cell are connected in series in a manner that the potential increases as the Z coordinate increases, and in the sub-stack 2, the fuel cells Cell are connected in series in a manner that the potential decreases as the Z coordinate increases.

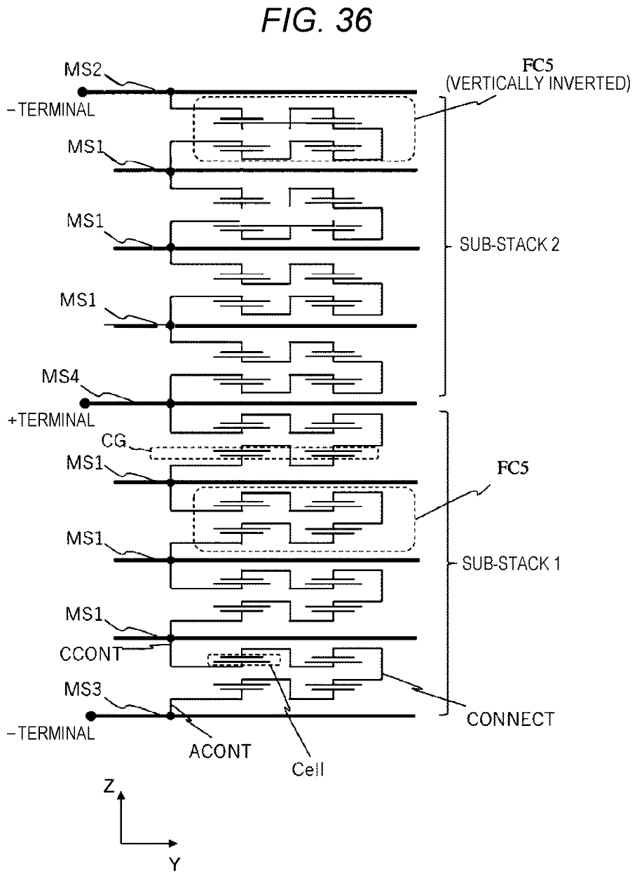

FIG. 36 shows the equivalent circuit diagram of the fuel cell stack shown in FIG. 35. In the sub-stack 1, a structure (FC5) in which a total of four fuel cells Cell, which are two lower fuel cells Cell and two upper fuel cells Cell, are connected in series is formed in each boundary area between adjacent metal substrate layers (MS1, MS3, MS4).

In the sub-stack 2, a structure (FC5) in which a total of four fuel cells Cell, which are two lower fuel cells Cell and two upper fuel cells Cell, are connected in series is formed in each boundary area between adjacent metal substrate layers (MS1, MS3, MS4) in a vertically inverted structure from the sub-stack 1. The metal substrate layer MS4 is shared by the sub-stack 1 and the sub-stack 2. The sub-stack 1 and the sub-stack 2 can be connected in parallel to supply power to the outside.

Also, in the fuel cell stack of the modification of the fifth embodiment shown in FIGS. 35 and 36, similarly to the case shown in FIGS. 8A and 8B and FIGS. 9A and 9B, it is possible to obtain the effect of reducing the thicknesses in the Z direction of the flow path of the fuel gas Fuel, the flow path of the air Air, and the structure for one layer of the fuel cell Cell. In cases such as a case where the voltage increases excessively when the entire stack is connected in series, and the withstand voltage between the output terminals of the stack cannot be sufficiently ensured, the method of the present embodiment can be used to reduce the output voltage, thereby suppressing a power loss due to an electrical short circuit failure or a leakage current. In addition, compared to the structure of FIGS. 31 to 34, an insulating layer is unnecessary at the boundary portion of the sub-stack, and the metal substrate layer can be shared, so that the dimension in the Z direction of the entire stack can be easily reduced.

In FIGS. 35 and 36, one FC5 has been formed in each area between adjacent metal substrate layers in the sub-stack, but it is also possible to form FC1, FC2, FC3, or FC4 between adjacent metal substrate layers in the sub-stack. It is also possible to connect a plurality of FC1, FC2, FC3, FC4, or FC5 in parallel to each other between adjacent metal substrate layers in the sub-stack.

As the shape of the metal substrate layer and the shape of the fuel cell Cell, a rectangular shape as in the first to third embodiments can be used, but as in the fourth embodiment, a circular metal substrate layer, a ring-shaped fuel cell Cell, and a fuel cell Cell having a shape obtained by dividing a ring shape in a concentric direction can also be used. In FIGS. 35 and 36, the number of sub-stacks has been two, but may be three or more.

According to the embodiment configured as described above, the size of the fuel cell stack is reduced by using the metal substrate layer to alternately invert and stack the fuel cells adjacent in the stacking direction such that the anode layers face each other and the cathode layers face each other, and by forming the common flow path of the fuel gas in the area where the anode layers face each other and forming the common flow path of the oxidant gas in the area where the cathode layers face each other to reduce the thickness of the flow path and set one metal substrate layer as the support structure for each two cell layers. By connecting the fuel cells in series in the stacking direction, the output voltage of the cells is increased to reduce the current and suppress a power loss due to parasitic resistance, despite the structure in which the fuel cells are stacked with the anode layers facing each other and the cathode layers facing each other, using the connection electrode formed at the end of the cell and the metal substrate layer.

The present invention is not limited to the embodiments described above but includes various modifications. For example, it is possible to simultaneously swap the anode and the cathode and swap the flow path of the fuel gas Fuel and the flow path of the air Air, and as a result, the positive electrode and the negative electrode of the external output terminal are swapped. For example, the embodiments described above have been described in detail for describing the present invention in an easy-to-understand manner and are not necessarily limited to those having all the configurations described above. It is also possible to replace a part of the configuration of one embodiment with the configuration of another embodiment or to add the configuration of another embodiment to the configuration of one embodiment. Also, a part of the configuration of each embodiment can be added, deleted, or replaced with another configuration.

According to the above embodiment, it is possible to reduce the cost of the fuel cell stack, reduce the energy consumption, reduce the carbon emission, prevent global warming, and contribute to the realization of a sustainable society.

What is claimed is:

1. A fuel cell stack comprising a plurality of fuel cells each including a solid electrolyte layer and a first electrode layer and a second electrode layer that are formed across the solid electrolyte layer, the plurality of fuel cells being stacked with the first electrode layers or the second electrode layers of adjacent cells facing each other,
wherein
a common flow path that supplies a first gas to both of the first electrode layers facing each other is formed in an area where the first electrode layers face each other,
a common flow path that supplies a second gas to both of the second electrode layers facing each other is formed in an area where the second electrode layers face each other,
a connection electrode is formed at an end of the fuel cell, and
at least some of the plurality of fuel cells stacked are connected in series via the connection electrode.

2. The fuel cell stack according to claim 1, wherein
the first electrode layers of two each of the fuel cells adjacent in a stacking direction of the fuel cells are connected to each other, and the second electrode layers of the two of the fuel cells are connected to each other, to form one of parallel connection structures, and
the parallel connection structures are connected in series in the stacking direction.

3. The fuel cell stack according to claim 1, wherein
the second electrode layer of one of the fuel cells adjacent in a stacking direction of the fuel cells is connected to the first electrode layer of the other of the fuel cells via the connection electrode to form one of series connection structures, and
the series connection structures are connected in series in the stacking direction.

4. The fuel cell stack according to claim 1, wherein a plurality of the fuel cells are formed in the same plane with the first electrode layers and the second electrode layers oriented in the same direction.

5. The fuel cell stack according to claim 4, wherein a plurality of the fuel cells that are adjacent and formed in the same plane are connected in series by connecting the second electrode layer of one of the fuel cells to the first electrode layer of the other of the fuel cells via the connection electrode.

6. The fuel cell stack according to claim 5, wherein the first electrode layers of two of the fuel cells adjacent in a stacking direction of the fuel cells are connected to each other, and the second electrode layers of the two of the fuel cells are connected to each other, to form a parallel connection structure.

7. The fuel cell stack according to claim 5, wherein the fuel cells adjacent in a stacking direction of the fuel cells include both fuel cells with the first electrode layers and the second electrode layers electrically insulated from each other, and fuel cells with the second electrode layer of one of the fuel cells connected to the first electrode layer of the other of the fuel cells via the connection electrode.

8. A fuel cell stack comprising:
a plurality of metal substrate layers each having a structure in which a plurality of through-holes serving as a flow path of a first gas, a plurality of through-holes serving as a flow path of a second gas, and one through-hole for a fuel cell or a plurality of through-holes for fuel cells are formed, and connection is made to the plurality of through-holes serving as the flow path of the first gas or the plurality of through-holes serving as the flow path of the second gas via a flow path formed inside each of the plurality of metal substrate layers; and
fuel cells each including an electrolyte layer, and a first electrode layer and a second electrode layer formed across the electrolyte layer, the fuel cells being bonded to both surfaces of each of the plurality of metal substrate layers so as to cover the through-hole for the fuel cell with the first electrode layers or the second electrode layers facing each other,
wherein
the metal substrate layers are stacked such that the plurality of through-holes serving as the flow path of the first gas and the plurality of through-holes serving as the flow path of the second gas are connected in a stacking direction at an interval ensuring space for the flow path so as to prevent contact between the fuel cells bonded to each of the metal substrate layers, and
at least some of the fuel cells bonded to front and back surfaces of the metal substrate layers are each electrically connected to the first electrode layer of the fuel cell on one of the surfaces and electrically connected to the second electrode layer of the fuel cell on the other of the surface to be electrically connected in series in the stacking direction via the metal substrate layer.

9. The fuel cell stack according to claim 8, wherein a plurality of the through-holes for the fuel cells in the metal substrate layer are formed, fuel cells separate from each other are bonded so as to cover the plurality of through-holes for the fuel cells in the metal substrate layer, the metal substrate layer and the first electrode layer of each of some of the plurality of fuel cells are connected on one surface of the metal substrate layer, the first electrode layer of each of the rest of the fuel cells is connected to the second electrode layer of another of the fuel cells and is insulated from the metal substrate layer, the metal substrate layer and the second electrode layer are connected on the other surface of the metal substrate layer, and the second electrode layer of each of the rest of the fuel cells is connected to the first electrode layer of another of the fuel cells and is insulated from the metal substrate layer.

10. The fuel cell stack according to claim 8, wherein the second electrode layers or the first electrode layers are electrically connected to each other between the fuel cells that are bonded to the metal substrate layers adjacent and face each other via the space for the flow path.

11. The fuel cell stack according to claim 9, wherein the second electrode layers and the first electrode layers are insulated from each other between the fuel cells that are bonded to the metal substrate layers adjacent and face each other via the space for flow path, and in the fuel cells with neither the second electrode layer nor the first electrode layer electrically connected directly to the metal substrate layer, the first electrode layer of one of the fuel cells facing each other and the second electrode layer of the other of the fuel cells are electrically connected to each other.

12. The fuel cell stack according to claim 8, wherein the metal substrate layer has a rectangular shape or a circular shape.

13. The fuel cell stack according to claim 8, wherein the through-hole for the fuel cell in the metal substrate layer has a drop hole large enough to accommodate the fuel cell and an eaves structure at a bottom, and a part of the fuel cell in a thickness direction is embedded in the metal substrate layer.

14. The fuel cell stack according to claim 8, wherein the metal substrate layer is formed by bonding two metal substrate layers having a front and back inverted symmetrical structure.

15. The fuel cell stack according to claim 8, wherein the fuel cell stack is divided into a plurality of sub-stacks in which fuel cells are connected in series in a stacking direction of the metal substrate layers by electrically terminating series connection with some of the metal substrate layers as a boundary in the stacking direction of the metal substrate layers, while gas flow paths are connected, and the plurality of sub-stacks are connected in parallel to each other.
